(19) United States
(12) Patent Application Publication
(10) Pub. No.: US 2006/0280724 A1
(43) Pub. Date: Dec. 14, 2006

(54) Identification of ligands that enable endocytosis, using in vivo manipulation of neuronal fibers

(76) Inventors: Ian A. Ferguson, Crafers West SA (AU); Hiroaki Tani, Eden Hills SA (AU)

Correspondence Address: PATRICK D. KELLY, 11939 MANCHESTER #403, ST. LOUIS, MO, 63131, US

(21) Appl. No.: 10/423,683

(22) Filed: Apr. 26, 2003

Related U.S. Application Data
(63) Continuation-in-part of application No. 10/188,184, filed on Jul. 2, 2002, now abandoned.
Application No. 10/188,184 is a continuation-in-part of application No. 09/705,428, filed on Nov. 4, 2000, now abandoned.

(30) Foreign Application Priority Data
Apr. 26, 2002 (AU) PS-1935

(51) Int. Cl. C40B 30/06; C40B 50/06

(52) U.S. Cl. 424/93.2; 435/5

(57) ABSTRACT

In vivo screening is used to identify and isolate ligands that drive endocytosis (internalisation) of molecules into animal cells. These ligands can transport passenger molecules (drug or diagnostic compounds, genetic vectors, etc.) into targeted classes of cells. A population of candidate ligands, such as a phage display or combinatorial library, is placed in a rat leg, in contact with a sciatic nerve bundle, and a ligature is tightened around the same nerve bundle at the hip. After a delay, to enable ligands that bind to endocytotic receptors on the nerve fibers to be internalised and transported within the fibers, fiber segments are harvested from the ligature site in the hip. Ligands that entered the harvested nerve segments can be isolated, sequenced, reproduced, etc. If desired, rats can be transformed to express human endocytotic receptors, to allow selection of ligands that will be transported into targeted human cells.

### RELATED APPLICATIONS

This application is a continuation-in-part of U.S. utility patent application Ser. No. 10/188,184, filed on Jul. 2, 2002, which in turn was a C-I-P of U.S. application Ser. No. 09/705,428, filed on Nov. 4, 2000, now abandoned. The '428 application also claimed the benefit of an Australian provisional patent application, number PL-8405, filed Nov. 4, 1999.

This application also claims priority based on Australian provisional application PS-1935, filed on Apr. 26, 2002.

### FIELD OF THE INVENTION

This invention relates to biochemistry, genetic engineering, and medicine. In particular, it relates to delivery of molecules into cells, by making use of specific binding molecules (called ligands) that will bind only to particular molecules on the surfaces of targeted cells. This allows a ligand to transport other attached molecules (such as therapeutic, diagnostic, or analytical compounds, or genetic engineering vectors) into targeted cells.

### BACKGROUND OF THE INVENTION

Any reference herein to cell or cells, in a context which involves receptors or ligands, is limited to animal cells, and excludes plant or microbial cells unless otherwise noted. The only use for bacterial cells that are mentioned at various locations below is for replicating bacteriophage viruses.

Any reference herein to in vivo refers to a procedure that is carried out, in whole or at least in substantial part, inside the body of an animal. In some situations disclosed herein, it is necessary to sacrifice a small animal (such as a rat) near the end of an in vivo screening process, in order to harvest segments of nerves containing internalised molecular complexes. Nevertheless, crucial steps in the screening procedure must be performed inside an animal's body, preferably while the animal remains fully alive. Accordingly, these screening procedures are referred to herein as in vivo, to distinguish them from other types of screening procedures that are performed in vitro (i.e., in solution, such as in cell culture solutions).

Proper functioning of the outer membrane of an animal cell, which separates the interior of the cell from the fluids that surround the cell (including blood, lymph, and tissue gel), is crucial to the existence and metabolism of that cell. Unlike plant cells and many types of microbial cells, animal cells do not have stiff cell walls, and instead must rely on flexible membranes to enclose and protect them.

The proper functioning of a cell's outer membrane requires a complex balancing act. On the one hand, the outer membrane must be sufficiently strong and exclusionary to protect the cell, and to maintain its high concentrations of essential internal compartments and molecules. On the other hand, there must also be numerous active processes that allow nutrients and other selected molecules to enter the cell, and that allow waste products, various proteins, and numerous other molecules that were synthesized inside the cell, to leave the cell. Therefore, the entry and exit of molecules into or out of an animal cell must be highly selective, and tightly regulated, by the cell's outer membrane.

Because the structures and functions of cell membranes, surface receptors, and other types of surface molecules are highly important in this invention, an introduction and summary of those structures and functions is provided in the following section. Anyone who is already familiar with those structures and functions can skip the next section, and go to the following section on ligands and ligand receptors.

Overview of Cell Membranes and Surface Receptors

The background information in this section is an overview, intended for readers who do not specialize in biochemistry, but who are nevertheless obliged to evaluate this patent application (or any patent issuing therefrom). More information (with well-done and helpful color illustrations) is available from numerous other sources, including review articles and textbooks that are available in any medical library. Two reference books that are highly recommended, and that are widely available and used as standard texts in nearly any medical school, are Textbook of Medical Physiology, by Guyton (or by Guyton and Hall, for recent editions), which offers a good overview and introduction, and Molecular Biology of the Cell, by Alberts et al, which offers much more information on these particular subjects. In Guyton & Hall's ninth edition, 1996, the relevant pages on cell membranes, surface receptors, and endocytosis include pages 12-14, 19-20, and 43-45; in Alberts et al's third edition, 1994, the relevant pages include 478-488, 618-625, and 731-744.

Briefly, the outer membrane of a cell is a “bilayer” that is made of two adjacent layers of amino-phospho-lipid molecules. Each of these molecules has both a “head” portion (which is water-soluble), and a “tail” portion (which is not).

In the “head” portion, the amino group (which has a positive charge) is next to the phosphate group, which has a negative charge. Since these two opposite charges are positioned next to each other, the head portion is “polar”, and can mix readily with water, which is also polar.

By contrast, the “tail” portion is made of hydrocarbon chains, which are non-polar and do not mix with water. These are the same types of compounds found in oil and grease.

Since the “heads” are water-soluble while the “tails” are not, phospho-lipids that are mixed with water will organize into bilayer spheres. The outermost layer, which contacts water, is made of the water-soluble “heads”, and the innermost surface (which will contact a droplet of water that is enclosed within the bilayer sphere) is also made of the “heads”. The oily “tails” of both of the two layers will line up next to each other, in a manner which places them inside the bilayer, which thereby effectively becomes a membrane. This arrangement allows the hydrophobic tails to mingle only with each other, so that they will not have to contact the water that both surrounds, and fills, the bilayer capsule.

This type of “lipid bilayer” forms the basic scaffolding and structure of a cell membrane. However, it is not the only crucial part of a cell membrane, because hundreds or thousands of specialized protein molecules must be embedded in the membrane of any living cell, in order to allow the cell to function properly and stay alive. The lipid bilayer is essentially inert; it provides a structural scaffolding that holds things in place, and it also provides what is, in effect, a layer of chemical and electrical insulation, which allows a cell to sustain various chemical and electrical gradients across that membrane.

By contrast, the proteins that are embedded in the lipid bilayer can be regarded as “worker” molecules. Those proteins must handle, drive, and regulate the transporting, signalling, responding, and other activities that enable a cell membrane to function properly, in ways that keep the cell alive and active.

The proteins that are exposed and accessible on the surfaces of cells have amino acid sequences that cause them to become embedded in the lipid bilayer, in a secure, stable, and natural manner. Most surface proteins (which includes receptors) have three distinct domains: (1) an external sequence which is hydrophilic, and which extends outside the cell and directly contacts and interacts with the watery liquid surrounding the cell; (2) a hydrophobic domain in the center portion of the protein, which will be comfortable and stable in the oily and hydrophobic lipids that are positioned inside the bilayer membrane; and, (3) an internal hydrophilic sequence, which will remain inside the cell interior, in contact with the watery fluid inside the cell (i.e., the cytoplasm).

It should also be noted that cell surface proteins are not the only molecules that are exposed on the surfaces of cells. An animal cell surface also bristles with carbohydrate molecules, which are hydrocarbon molecules that have multiple hydroxy groups attached to them. The hydroxy groups cause these carbohydrate molecules to be hydrophilic, so they can readily interact with the watery fluid outside a cell. Most of these carbohydrate molecules are attached to the proteins on the cell surface (usually through oxygen linkages that are called “glycoside” bonds, thereby causing these protein-carbohydrate complexes to be called glycoproteins, or proteoglycans), or they are attached to the phospholipids that make up the outer layer of the lipid bilayer membrane.

There are certain types of surface carbohydrates that are likely to become important in certain aspects of this invention, because these surface carbohydrates can function as passageways that can be used to activate and drive the process of internalizing ligand molecules that bind to these carbohydrates. Tetanus toxin and cholera toxin offer two examples of known ligand molecules that will bind specifically to particular surface carbohydrate molecules, in a manner which activates and drives internalisation of the resulting ligand-carbohydrate complex. Therefore, these types of ligand-binding reactions involving surface carbohydrates, rather than membrane-embedded surface proteins, can provide alternate “gateways” for carrying out this invention; and, this invention offers a powerful method for identifying and using additional, as-yet-unknown carbohydrate-containing surface molecules that can internalise other types of ligands. Therefore, although most of the discussion below focuses on membrane-embedded cell surface proteins, as an exemplary class of ligand-binding internalising molecules on cell surfaces, it should be kept in mind that this same approach can also be used with ligand-binding carbohydrate-containing surface molecules and possibly other types of cell surface proteins.

There are several different ways to categorize cell surface proteins. In order to highlight certain important traits of those receptors that are of particular interest herein, the discussion below will briefly mention three general categories of receptors, so that two of those categories can be set aside for now, while attention is focused on the third category, which offer the best subjects for clearly and conveniently describing and illustrating the workings and mechanisms of this invention.

One category of cell surface proteins which are not of special interest herein includes “ion channel” proteins. These proteins are actively involved in transporting small ions (which are usually single atoms that have an ionic charge, such as sodium, Na⁺, potassium, K⁺, calcium, Ca⁺⁺, and chlorine Cl⁻) into or out of a cell, through specialized channels that pass through the membrane. Those ion channels usually have two main structural parts: (i) a “tunnel” portion, which passes through the lipid bilayer membrane; and (ii) a “gate” structure, which sits at one end of the tunnel, and which opens and closes in response to various signals. As mentioned above, ion channel proteins will not be further discussed.

The second category of cell surface proteins that will not be discussed at any length herein includes receptors that interact with neurotransmitters (such as acetylcholine, dopamine, serotonin, etc.) and/or electrochemical signals. These types of receptors receive and transmit nerve impulses, and they control contractions of the muscles. These receptor proteins operate extremely rapidly, in timespans measured in milliseconds. They also reset themselves extremely rapidly, as soon as a nerve impulse has been processed, so that they can be ready to receive the next nerve impulse. For the sake of simplicity, these cell surface proteins will not be discussed further.

Ligand Receptor Proteins

The cell surface proteins that are particularly useful for describing and illustrating the workings of this invention are referred to herein as “ligand receptor” proteins.

A first distinguishing trait of ligand receptor proteins that are exposed on cell surfaces is that each particular type of receptor, within this class of proteins, will interact with, and will be triggered and activated by, only a single type of extracellular molecule (or, in some cases, only a very small and limited group of structurally similar extracellular molecules). This binding mechanism can be regarded as being directly comparable to a “key-in-lock” arrangement; only a small number of keys, having certain exact and limited sizes and shapes, can fit into a certain lock.

A second distinguishing trait of ligand receptor proteins on cell surfaces is that, when a binding reaction does occur between a ligand molecule and a receptor protein, then the two molecules will remain bound to each other for an extended period of time. Instead of being measured in milliseconds, as occurs with neurotransmitters, ligand binding reactions usually can be measured in minutes, hours, or even days. These reactions frequently trigger a series of events in which both the ligand and the receptor will be taken inside the cell, where both of them typically will be eventually digested, so that their building blocks can be recycled.

To illustrate how and why this occurs, consider the case of a ligand that is a polypeptide hormone (i.e., a polypeptide molecule that is released into extracellular fluids by one type of cell, and that exerts effects on other types of cells which it subsequently contacts and binds to; this term includes paracrine and endocrine hormones, such as growth hormones, nerve growth factors, etc.). Some hormones exert effects that last for minutes or hours (such as insulin, as one example), while other hormones (such as growth hormones) can permanently alter the size, shape, and health of an organism.

In order to provide a mechanism that will help control and regulate the actions of hormones, most hormones are usually taken into the cell they contact and bind to, by a process called “endocytosis”. In most cases, the hormone-receptor complex will eventually be digested by that cell, without ever being released. This places a minor burden on hormone-releasing cells to make and release larger quantities of a hormone. However, this mechanism provides a much more reliable way to control the actions of hormones. If hormone molecules were released by their receptors, they would simply float back into the extracellular fluid, and they could then contact and activate additional receptors on other cells, in a manner that could lead to unregulated and potentially uncontrollable effects.

Not all ligands are hormones. Instead, the general category of ligand molecules includes any and all extracellular molecules that will bind to “ligand receptor” proteins on the surfaces of cells, in a manner that: (i) is highly specific, in a manner comparable to a “lock-in-key” system; and, (ii) will last for a substantial period of time, as distinct from other types of receptor binding reactions that last only for a few milliseconds (such as binding reactions involving neurotransmitters, nerve impulses, and muscle contractions).

Internalisation of Ligands by “Endocytotic” Receptors

As mentioned above, when a ligand molecule binds to a surface receptor on a cell, one of the possible outcomes is that the ligand molecule and the receptor protein will remain bound to each other, and the “ligand-receptor complex” will be taken inside the cell. When this process of cellular “uptake” (also called intake) occurs, it can be referred to be any of several terms, including endocytosis, receptor-mediated endocytosis, and internalisation. As described below, it can also be referred to as pinocytosis (if the ligand is relatively small) or phagocytosis (if the ligand is relatively large).

As used herein, the terms “endocytosis” and “internalization” are used interchangeably, to refer to a cell-driven process in which an extra-cellular molecule (other than a nutrient or oxygen) which has become bound in a specific manner (usually referred to as “affinity binding”) to a molecule on the cell surface, is drawn into the cell interior. This process includes receptor-mediated endocytosis, involving ligands which bind to receptor proteins. It also includes the process in which ligands that bind specifically to other types of cell surface molecules (including surface carbohydrates) form other types of ligand complexes that are drawn into a cell. The terms endocytosis and internalization also include the processes called “pinocytosis” and “phagocytosis” (as briefly mentioned above, and as described in more detail below), provided that such processes involve specific binding of a ligand molecule to a cell surface molecule in a manner that forms a complex which is subsequently internalized by the cell.

Returning to receptor-mediated endocytosis as one type of endocytotic process that can be used to clearly describe and illustrate this invention, the binding of a ligand to the portion of a receptor protein that sits outside the cell will usually trigger some sort of conformational change. This change might involve an alteration in the shape and/or activity of that portion of the membrane-straddling receptor protein which sits inside the cell; alternately, the ligand-binding reaction may stimulate a ligand-receptor complex to move sideways within the cell membrane, in a manner that causes it to associate with other membrane-bound molecules. These types of protein conformation changes, in response to ligand binding reactions, are well-known, and are discussed in numerous reference works, such as Alberts et al, Molecular Biology of the Cell (third edition, 1994), pages 618-626 (which describe and illustrate endocytosis) and pages 636-641 (which describe clathrin proteins and triskelions, which aid and facilitate the process of endocytosis). Pages 731-734 also describe and depict (mainly by simplified cartoon-type drawings) the internal conformation changes that occur in “enzyme linked” and “G-protein-linked” surface receptors, when ligand binding reactions occur outside the cell; however, those types of receptors will not be discussed further herein unless they undergo a process of endocytosis as described herein.

Briefly, when an endocytotic receptor is involved, the binding of a ligand molecule to the exposed extra-cellular domain of the receptor will trigger a conformational change in the receptor protein, in a manner that will generate what is, in effect, an inward bulge on the inner surface of the cell membrane. This bulge typically triggers a response by “clathrin” molecules, which are protein complexes, each having three large and three small subunits, organized into a three-legged subassembly called a “triskelion”.

When a bulge begins to form on the inside surface of a cell membrane, these triskelion structures, which normally cluster together in soluble form near the inside of the cell membrane, will recognize and respond to the newly-forming bulge, as a triggering event. Those triskelion units will begin to coat the surface of the bulge, in a manner which helps to enable and induce the bulge to grow larger.

With the help of a triskelion “basket” that will begin to form around the bulge in the lipid bilayer, the bulge is enlarged, in a manner which is comparable to being sucked inside the cell. This converts the bulge into an “invagination”, and when the invagination reaches a size and length which cause it to have a “neck”, the neck is then narrowed and constricted, with the ongoing help of the triskelion basket, which continues to assemble its protein subunits into a generally spherical shape, comparable to a soccer ball or “buckyball” that is contained inside a framework of hexagon and pentagon surfaces formed by the triskelion proteins. This process, which continues to drive the invagination until a complete sphere is formed, results in a “pinching off” process, which frees and releases the newly-formed lipid capsule from the cell membrane. Once the newly-formed capsule is released from the outer membrane, it is called a “vesicle”.

After the vesicle has separated from the cell's outer membrane, the outer membrane will return fairly quickly to its normal shape. It should be recognized that during this entire process, the cell membrane never suffered from any breach or opening that would jeopardize the cell. Instead, the lipid bilayer that makes the outer cell membrane continued to fully enclose and protect the cell, even while it was undergoing a process (often called a “budding” process) that creates a smaller offspring, in the form of a fully-enclosed vesicle.

When newly-formed vesicles contain only small items, such as ligand-receptor complexes, this process is also referred to as “pinocytosis”, which was derived from Greek words which translate into, “the cell is drinking”. By contrast, if a newly-formed vesicle contains a substantially larger object (such as an entire bacterial cell which is being swallowed up by a macrophage), the process is called “phagocytosis”, which translates into “the cell is eating”. Pinocytosis is a normal and regular process, and occurs rapidly and frequently; among some types of cells that are in very active states, pinocytosis of certain types of nutrients has been measured to occur at a rate of more than once every two seconds.

When a small vesicle is released from the outer membrane and enters the cytoplasm, other molecules and organelles recognize it, and they remove the triskelion basket from the outer surface of the vesicle. This returns the clathrin/triskelion proteins to their soluble form, and they will move back to their normal position, just inside the cell membrane, where they will wait for the next endocytotic event to begin. The removal of the triskelion basket releases the vesicle, which in most cases is then transported to an endosome, lysosome, or other organelle inside the cell.

Additional types of proteins also become involved in at least some cases of endocytosis. Protein complexes called “adaptins” become involved when certain types of ligand-receptor complexes are bring drawn into a cell. These adaptin complexes are involved in “selective” transport, and they apparently cause at least some types of ligand-receptor complexes to be transported to particular destinations inside a cell, rather than undergoing non-specific transport to a digestive organelle such as a lysosome.

Still other protein complexes called “coatomers” are also involved in the formation and transport of at least some types of lipid bilayer vesicles, possibly including some vesicles involved in endocytotic processes. However, coatomers apparently are involved mainly in the process of “exocytosis”, in which molecules that were synthesized inside a cell are carried to and through the cell membrane, so that they are secreted by the cell.

Finally, it should be noted that in most animal cells, endocytosis of ligand-receptor complexes involves transport of the lipid vesicle only over short distances (the typical diameter of most animal cells is in the range of about 10 microns, or 1/100 of a millimeter). However, ligand-receptor complexes in neurons can travel much longer distances. Many neurons in the brain and spinal cord have long fibers (including axons, dendrites, and “processes”) that extend for multiple centimeters, and some types of neurons that carry nerve signals in humans from a hand or a foot to the spinal cord (or vice-verse) have fibers that extend more than a meter. Accordingly, endocytosis that occurs within these types of long fibers must be able to carry a ligand-receptor complex all the way from the most distant tip of the neuronal fiber, where some ligand-receptor complexes will first enter a neuron, to the main cell body of the neuron, regardless of how far that distance may be.

On the subject of transport of a compound that has successfully reached the interior of a targeted cell, the term “retrograde transport” should be introduced and briefly described. “Retrograde” transport occurs when a molecule is transported from an extremity (or “terminal”) of a neuron, along an axon or dendrite, into the main body of the cell, where the nucleus is located. This direction of movement is called “retrograde”, because it runs in the opposite direction of the normal outward movement (called “anterograde” transport) of most molecules in a cell. In a neuron, most of the molecules that are being actively transported within the cell (excluding the basic nutrients, glucose and oxygen, and the basic metabolite, carbon dioxide) were synthesized in or near the nucleus, and are being transported away from the main cell body, toward the outer membrane and/or the terminals of the neuronal fibers.

The term “axonal transport” should also be recognized and understood. Many types of nerve cells have a single main fiber, which is the largest fiber that extends out from the main cell body. That largest fiber is usually called the axon. The term “axonal transport” includes and refers to any form of transport of molecules within an axon, regardless of which direction the molecules are travelling (i.e., toward the cell body, or away from the cell body). Therefore, retrograde transport that occurs within an axon is a form of axonal transport. However, the term “retrograde transport” is preferred herein, since it also indicates the direction of travel.

Limitations on Ligand-Receptor Endocytosis

Since animal cells have evolved tightly regulated mechanisms for facilitating the entry into the cell of only some molecules, while keeping out other molecules, mere binding of another molecule to a receptor is typically not sufficient to stimulate the process of receptor-mediated endocytosis. The internalisation process requires the binding, to the receptor, of either: (i) the correct and natural ligand molecule; or, (ii) in some cases, an artificial drug molecule that was designed to closely mimic the binding of the authentic ligand, in a manner that will allow the drug molecule to be taken inside the cell so that the drug can exert a useful therapeutic effect.

Antibodies provide an example of molecules that can be generated, rather easily, to bind to membrane receptors; however, antibodies also illustrate quite effectively the principle that mere binding of a molecule, to an endocytotic receptor, may not be enough to trigger and drive the process of endocytosis. It is a relatively simple matter to generate antibodies that will bind with high specificity to any particular type of membrane receptor; this can be done by injecting proteins that contain sequences from the exposed portion of a cell receptor, into an animal of another species, in a way that will trigger an immune response. It also is fairly easy to generate unlimited supplies of monoclonal antibodies that will bind selectively to surface receptors, by using conventional techniques to create and then screen hybridoma cell lines.

However, even though creating such antibody preparations is relatively easy and straightforward, there are few reports of any such antibody preparations that can successfully trigger and then satisfactorily complete the entire process of receptor-mediated endocytosis. In addition, with regard to this invention, there is a long series of additional and important limitations that must be overcome, somehow, before any such antibody preparations can be used safely and effectively in either human or veterinary medicine.

The first major obstacle, in this series of problems, arises from the fact that this current invention is targeted primarily at improved ways of delivering useful molecules into cells, and in particular into neurons (and even more particularly, into neurons located inside brain or spinal tissue, which therefore are protected by the blood-brain barrier). This type of treatment, of neurons, poses a very difficult yet very important challenge; the inability of modern medicine to cure a number of hugely important neuronal diseases (including Alzheimer's disease, Parkinson's disease, and schizophrenia, as just three examples) poses one of the most important, pressing, and intractable problems in all of modern medicine. Even if numerous antibody preparations have been identified that can trigger and then complete the process of receptor-mediated endocytosis, in cells other than neurons, a pressing need still remains for antibody preparations (or other ligand preparations) that can trigger, drive, and complete the process of receptor-mediated endocytosis, in neurons.

There are very few known antibody (or other ligand) preparations that can accomplish that result in neurons, and most of the data from those antibody preparations were created using small animals. Unless special and elaborate steps are taken to generate hybridized interspecies antibodies (such as antibodies that have entirely human sequences, except for a limited region or domain that contains a particular binding sequence that was first isolated and sequenced from a mouse monoclonal antibody preparation), antibodies from small animal species cannot be used in human medicine, in any form in which antibodies from the non-human species would be injected or otherwise introduced into a human body, because they will stimulate an immune response. However, it should be noted that a number of non-human antibody preparations have been approved for diagnostic or analytical purposes, such as tests in which a blood, urine, or saliva sample from a human is mixed with non-human antibodies in a test tube, dish, or other holding device.

One example of an antibody preparation that reportedly can trigger and then complete the process of receptor-mediated endocytosis in rat neurons is a monoclonal antibody, initially designated as IgG-192 and subsequently called MC192, described in Chandler and Shooter 1984. The MC192 antibody binds specifically to a rat neuronal receptor that was known in the mid-1980's as the “low affinity nerve growth factor receptor”, and that was subsequently designated as the p75 receptor.

It should be noted that when a certain type of cell receptor that is of interest is identified in a mammal used in laboratory research (such as mice or rats), closely similar “homologues” of the same receptor can usually be found in other mammalian species, including humans (indeed, homologues exist between even more widely varying creatures, and many human genes have clear and direct homologues in even the tiniest animals, such as fruit flies and nematodes, which are widely used in genetic research).

The process of identifying homologues in different species can be performed in any of several ways, such as: (i) by using monoclonal antibodies, generated by steps that used small mammals, as reagents to bind to human or other homologous proteins; or (ii) by using a known DNA sequence, isolated and sequenced from the small animal species, as a “probe” in DNA hybridization tests. Because of the amount of homology between mammalian genes that perform essentially the same function, a DNA sequence from even a small mammal, such as a rat, is usually able to bind to a homologous gene from a human DNA library, with sufficient avidity to allow identification and isolation of the targeted human gene, thereby allowing the human homologue to be isolated and sequenced. Similarly, because of the degree of homology between receptor proteins that perform essentially the same function in different species, a monoclonal antibody that can bind to a certain receptor protein in a laboratory animal is likely to also bind to the human homologue with sufficient avidity to allow identification and isolation of the targeted human protein. Those are just two of the methods that can be used to identify homologues in different species; other methods are also known.

Accordingly, various homologues of the “low affinity” (p75) nerve growth factor receptor have been identified, from animals that include rats and rabbits, as well as from humans. The p75 genes from each of those species has been fully sequenced, and monoclonal antibodies have been generated that will bind specifically to each of those homologues, from each of those species.

Some years after the MC192 monoclonal antibody (which binds to p75 receptors in rats) became available, it was reported by other researchers that when that particular antibody was radiolabelled and then injected into rats, it was internalised and retrogradely transported into the cell bodies of neurons that express the p75 receptor on their surfaces (Yan et al 1988; other aspects of that experiment are discussed in more detail below). These results were similar to the results that were obtained when a radiolabelled ligand, mouse nerve growth factor (abbreviated as mNGF), was injected into rats. In a manner comparable to radiolabelled NGF, the injected radiolabelled IgG-192 antibodies became bound to p75 receptors at the tips of the rat motor neurons (this was possible, because the tips of these neurons are accessible outside the blood-brain barrier). The binding of the labelled IgG-192 antibodies to the p75 neuronal receptors triggered receptor-mediated endocytosis, and the labelled antibodies were carried, by retrograde axonal transport, to the main cell bodies of the nerve cells, where they were found by radiodetection methods after the rats had been sacrificed.

That example may prove that it is theoretically possible to develop an antibody that can trigger and then complete the process of ligand-receptor endocytosis; however, major obstacles still remain before that type of research discovery can be used in human medicine, and two crucial sets of questions immediately arise.

The first set of questions center on the difficulties of extending those types of findings, to human medicine. Obviously, it is highly problematic and in many cases illegal to inject antigens or unproven antibody fragments into humans. Even more importantly, the screening tests that would need to be performed, in order to prove that some particular antibody type that works well in animal tests can also work well in humans, would be very difficult and potentially impossible, unless they are done in ways that currently are not acceptable in human research. If one begins to seriously contemplate the obstacles that would confront such research tests (which are likely to require samples of spinal tissue to be removed and then analyzed to determined whether radioactively-labelled tracer molecules actually reached the spinal cord), one ends up pondering tests on murderers who are condemned to be executed within the next few days, or on people who are going to die of cancer or other terminal diseases within the next few days. However, tests involving removal of solid tissue from a human spinal cord, so the tissue can be analyzed, are not allowed in any industrial nation where modern medical practices are used.

The second set of difficult questions centers on the issue of what types of molecules an “endocytotic receptor antibody fragment” might be able to carry along with it, into a cell interior, if the antibody fragment itself can work as hoped as an endocytotic trigger. Clearly, there is no therapeutic value in having antibody fragments, with nothing else attached, pulled into the interiors of neurons. Instead, such antibody fragments must be regarded merely as vehicles (or as locomotives, which could be used to pull a train). They will not be useful unless they can carry or pull some type of “passenger” or “payload” molecule into the neurons they are entering.

However, it must be recognized from the outset that coupling any additional molecular fragment to an endocytotic antibody fragment will necessary enlarge the resulting conjugate. Depending on how much larger the conjugate will be, this enlargement may substantially reduce the ability of the conjugate to be pulled into neurons with the same level of efficacy as the antibody fragments alone. There is no good way to answer that type of question at an early stage, during the research that will be necessary on any such antibody fragment. Instead, the transport vehicle must be evaluated and proven to work, on its own, before it becomes worthwhile to test that vehicle's ability to carry (or pull) passenger or payload components.

Accordingly, since the reports published to date indicate that only a small subset of the antibodies generated against endocytotic receptors may be capable of mimicking a natural ligand's ability to trigger and then complete the process of receptor-mediated endocytosis, the process of testing each of dozens or even hundreds of monoclonal antibody candidates, to identify rarely-occurring internalising antibodies, renders these problems even more difficult and expensive.

Genetic Vectors as Exemplary Illustrations of this Invention

The next few Background sections focus on genetic engineering vectors (i.e., man-made constructs that are used to insert transforming or transfecting genes into cells).

This invention is not limited to genetic engineering, and instead discloses general methods for introducing a variety of molecules that are useful (such as for medical, diagnostic or other analytical, or research purposes) into cells, in ways that will affect only certain narrowly focused and limited types of target cells, to minimize unwanted side effects.

Nevertheless, genetic engineering vectors offer a useful system for describing and illustrating this invention, for several reasons. One major factor is this: genetic vectors usually require the transport, into a cell, of large molecular complexes, up to and including entire virus particles, which are hundreds or thousands of times larger than most drug molecules. If a ligand can help pull an entire virus particle or other genetic vector into a cell, it will very likely be quite capable of transporting any drug molecule, of any size that is of practical interest, into cells. Indeed, if a ligand can drive internalisation of an entire virus particle, it likely can also drive internalisation of drug formulations that contain multiple drug molecules, in a complex or conjugate form. As just one example, methods have been developed for creating connector molecules that can be used to couple drug molecules to “carrier” molecules until after a conjugate enters a cell; then, these connector molecules will then release the drug molecules from the carrier molecules, inside the cell (see, e.g., U.S. Pat. No. 4,631,190 (Shen et al 1986) and U.S. Pat. No. 5,144,011 (Shen et al 1992)). Using techniques known to those skilled in the art, it may be possible to use such spacer molecules (or other types of molecules that can accomplish similar goals) to couple two or more drug molecules to a single “carrier” ligand.

A second major factor is this: despite the shortcomings of viral vectors, and despite the small number of truly useful and widely applicable medically therapeutic accomplishments in the field of gene therapy, a large foundation of useful methods, reagents, and knowledge has been developed in the field of genetic therapy for medical problems. Accordingly, the development of better ligand molecules, that can efficiently trigger and drive the transport of genetic vectors into specific and limited types of targeted cells, can “dovetail” very effectively with that already-large foundation of information and reagents.

On the subject of genetic engineering, one more issue of terminology needs to be clarified. The terms “transfect” and “transform” are used interchangeably herein. Both terms refer to a process which introduces a foreign gene (also called an “exogenous” gene) into one or more preexisting cells, in a manner which causes the foreign gene(s) to be expressed inside the cells, to form polypeptides that are encoded by the foreign gene. As used by some (but not all) scientists, “transfect” implies that a foreign gene is likely to be expressed by the cells only in a transient, time-limited manner, in a manner analogous to an infection which lasts only for a while, and is eventually stopped. By contrast, “transform” tends to imply a permanent genetic alteration that will be passed on to any and all progeny cells, usually due to integration of the foreign gene(s) into one or more cell chromosomes. However, the boundary lines between those terms can become blurred in various situations, and the distinctions between those two terms are not used consistently by all scientists. Accordingly, “transfect” and “transform” are used interchangeably herein, regardless of how long a foreign gene might continue to be expressed after it enters target cell(s).

Virus Entry into Cells; Viral Vectors

This background discussion will now shift to viruses, because they have evolved a number of ways to inject various types of molecules (including DNA, RNA, and proteins) into cells, and because they have been manipulated by researchers in ways that have generated vectors that have been used (with limited success, as discussed below) to genetically transform animal cells in various ways.

The evolutionary selection pressures that have led to the assortment of wild-type viruses that can infect animals have selected, very efficiently, for two traits in any successful strain of virus: (i) the viral polypeptides must be able to efficiently attach themselves to receptor proteins or other molecules that are accessible on the surfaces of host cells; and, (ii) the viral particles must then be able to efficiently deliver their genetic payloads into a cell. The viral surface proteins that are able to dock with and bind to surface proteins on susceptible cells have been generated, during the course of evolution, by a process of repeated rounds of trial and selection, in which variant and mutant viral proteins can be generated much more rapidly, and with much greater variety, than mutations in the genes or proteins of the host cells. Nevertheless, it must be recognized that in this selection process, acting over eons, the host cells also have played critical roles, by selecting and replicating those particular viruses which carry genes that encode viral proteins that can efficiently enable delivery of viral genetic material through the protective membranes of the susceptible host cells.

In view of the highly effective mechanisms that viruses use to inject genes into cells, most attempts to develop methods and reagents for gene therapy in medicine have focused and relied on genetically modified viruses. Viral vectors heavily dominate the scientific and medical literature that describes efforts to use gene therapy, in humans.

However, even though viral vectors have enjoyed some success, they have not been entirely satisfactory, or even adequate, for actual medical use. This is shown by the fact that actual gene therapy on humans is still in a stage of struggling and generally unsuccessful infancy, even though 20 years have passed since skilled and respected physician-researchers said they would soon be ready to begin human clinical trials. As this is being written, in early 2003, the total number of human patients who have been treated by virus-based gene therapy in approved clinical trials around the world is believed to be only in the hundreds, even though millions of other people have died or continue to suffer terribly from diseases that might well have genetic cures, if adequate and effective delivery methods could be developed and made available.

Accordingly, various efforts have been made to develop a number of non-viral vectors, for genetic transformation of animal cells.

Non-Viral Vectors

Background information on various classes of non-viral vectors that have been developed for potential use in genetic engineering and gene therapy, is contained in the above-cited parent application Ser. No. 10/188,184. The contents of that application are hereby incorporated by reference, as though fully set forth herein.

One class of non-viral vectors has attempted to use cationic materials (which have positive electrical charges, such as polylysine, polyethylenimine, etc.), in an effort to overcome the fact that naked DNA, which is negatively charged, normally is repelled by cell membranes, which are also negatively charged. These types of cationic materials are described in articles such as Li et al 2000 and Nabel et al 1997, and in patents such as U.S. Pat. Nos. 4,701,521 and 4,847,240 (both to Shen and Ryser).

Another approach involves the use of liposomes, which are comparable to lipid vesicles (although some types of liposomes contain only a single layer of lipid molecules, in the capsule). These types of liposomes usually also are designed to include cationic materials (such as a reagent called “Lipofectamine”, sold by the GIBCO/Life Sciences company) to overcome the negative charges on cell membranes. These types of efforts are described in articles such as Sahenk et al 1993.

Another approach uses two-component conjugates, which are formed by bonding a strand of DNA to a protein molecule that can either: (i) enter targeted cells, or (ii) help carry out a useful step after the conjugate has entered a cell, such as rupturing a lipid vesicle which contains the strand of DNA. This approach can use a viral protein, as part of the conjugate; however, the resulting conjugate will not be classified as a “viral vector” unless the conjugate is carried by a viral capsid. These types of efforts are described in articles such as Curiel 1997.

Finally, the fourth category of efforts to create and use non-viral vectors uses receptor-targeting gene vectors that are designed to trigger the process of endocytosis. This is the category of efforts and vectors that are of particular interest herein. Previous efforts to create such endocytotic-receptor-targeting vectors have been described in items such as U.S. Pat. No. 5,166,320 (Wu et al 1992), which involved receptor-targeting vectors that were intended to enter liver cells.

A limited number of molecules are known or believed to undergo receptor-mediated endocytosis, in neurons. Such molecules include (i) the non-toxic fragment C of tetanus toxin (e.g., Knight et al 1999); (ii) certain lectins derived from plants, such as barley lectin (Horowitz et al 1999) and wheat germ agglutinin lectin (Yoshihara et al 1999); and, (iii) certain neurotrophic factors (e.g., Barde et al 1991). Knight et al 1999 described a non-viral vector that used the C fragment of the tetanus toxin as a “carrier” molecule for DNA.

None of those efforts to develop non-viral vectors has even begin to approach success, on a medical or research level. Under the current state of the art, the “transformation efficiencies” of those non-viral vectors (i.e., their ability to deliver genetic material into targeted cells and then carry out or enable the subsequent steps that are necessary, inside the cell, to cause actual expression of the passenger genes into proteins inside the cell) does not and cannot begin to seriously approach the transformation efficiencies that can be achieved today with viral vectors.

And yet, as noted above, viral vectors are severely limited, and limiting, in their ability to actually enable effective and useful medical treatments, in humans.

Accordingly, the inventors herein set out to determine whether they could develop a practical and effective way to create novel components for non-viral and perhaps even virus-derived genetic vectors, that will function by binding selectively to endocytotic surface receptors on targeted classes of cells, and that can actually result in a completed process of endocytosis, in a way that will enable improved genetic vectors to be developed.

Yan et al 1988 published a study demonstrating that when 192-IgG (subsequently redesignated as MC192), a particular monoclonal antibody that binds, in rats, to nerve growth factor (NGF) receptor protein known as p75, was radiolabelled with an isotope of iodine (¹²⁵I) and then injected into the hindlimbs of newborn rat pups, the radioactivity could subsequently be detected in the cell bodies of the motor neurons, within the spinal cord. This indicated that the labelled 192-IgG antibodies had completed a series of three distinct steps: (1) the 192-IgG antibodies had become bound to p75 NGF receptor molecules, which were expressed on the terminals of spinal motor neurons, in the muscles of the lower limbs, (2) the antibodies had stimulated receptor-mediated endocytosis, which carried the labelled antibodies into the motor neuron cells; and, (3) the antibodies had been retrogradely transported, through the neuronal fibers, into the neuronal cell bodies, which are located in the spinal cord.

This study also showed that the expression of p75 NGF receptors, by motor neurons, did not persist into adult life, in rats. Within a week or two after birth, expression of NGF receptors, by those motor neurons, decreased to undetectable levels.

Later studies, using different antibodies that recognized the human NGF receptor, demonstrated that the NGR receptor is selectively upregulated, by neurons in patients suffering from amyotrophic lateral sclerosis (ALS, also known as Lou Gerhig's disease, which causes progressive paralysis due to loss of spinal motor neuron activity). In ALS patients, those neurons increase their expression of NGF receptor, shortly before they degenerate and die, in a manner which suggests that they are attempting to respond to stress, a lack of innervation, or other problems, by sending out signals that function as pleas for help. Taken together, these studies indicated that the NGF receptor can offer both a good marker molecule, for identifying neurons that are being damaged or dying in ALS, and a good target molecule, for developing therapies or genetic engineering vectors that target cells which begin expressing NGF receptors in abnormally high quantities. The concept of treating ALS, by means of targeted delivery of neurotrophin genes into spinal motor neurons that express NGF receptor proteins, is described in more detail in U.S. patent application Ser. No. 10/188,184, filed in July 2002, cited above and incorporated herein by reference.

Returning to the series of reports that grew out of Yan et al 1988, a problem arose which impeded further extension and development of that line of research. The 192-IgG monoclonal antibody is highly “species specific”; it binds only to rat NGF receptors, and will not even bind to mouse NGF receptors (let alone that of other species, such as humans).

When the Applicants embarked on the work described herein, no antibodies were known to be effective in activating and driving NGF receptor-mediated endocytosis, in mice. Without such antibodies, it was not possible to develop p75-targeting genetic vectors that could be tested in transgenic mice. This was a significant gap, since transgenic mice that have certain types of defective genes (such as superoxide dismutase (SOD) genes) are important animal models in ALS research.

Accordingly, the Applicants set out to determine whether they could generate alternatives to the 192-IgG antibody, that could emulate 192-IgG's ability to activate and drive receptor-mediated endocytosis, but that could also be tested and used in species other than rats (including mice, primates, and humans).

In their efforts to accomplish that result, they eventually settled upon the use of certain classes of biological reagents known as “phages” and “phagemids”. It is not conceded that the selection of those classes of reagents (and their accompanying methodology), for use in the efforts described herein, was obvious, as that term is used in the patent law; instead, it required substantial skill and experience, coupled with a number of creative and non-obvious insights, to enable the inventors to eventually assemble various disparate components and techniques into a systematic approach that would allow the components to interact properly together, to achieve the final result.

Nevertheless, it is conceded that the use of phages and phagemids, in genetic engineering, was known prior art. Therefore, the following sections provide additional background information on those two classes of reagents and tools.

Background Information on Phages and Phagemids

The word “phage” is a shortened form of “bacteriophage”, which translates into “bacteria eating”. Phages are a class of viruses which were given that name, because they will attack and destroy various types of bacteria.

This can be readily demonstrated by a simple technique that is widely used to isolate clonal colonies of phages. A thin layer (often called a “lawn”) of bacterial colonies is grown on the surface of a nutrient gel, such as agar, in a petri dish or other shallow holder. This “lawn” of bacteria becomes easily visible to the naked eye, when the bacteria reproduce to a point of creating a relatively even, somewhat whitish (or occasionally colored) coating on top of the otherwise translucent gel. If a dilute aqueous solution containing a relatively small number of phage viruses is then spread across the bacterial lawn, a number of clear spots (called plaques) will form in the bacterial lawn, where the bacteria were killed and lysed (i.e., broken apart into fragments) by colonies of phages.

Phages became of interest to molecular biologists for several reasons. Most carry single-stranded DNA (abbreviated as ssDNA) which makes them relatively easy to work with, and the sizes of their genomes places them in a useful intermediate level, larger and more sophisticated than most plasmids, but smaller than bacteria. They can be quickly and easily reproduced in any desired numbers, by allowing them to “feed on” bacteria (any references to eating, feeding, or similar activities by viruses are a rough description of the way phages will parasitize and grow within bacteria; many but not all phages will also kill and lyse their host cells). Most of the phages that are actively used in laboratories today can readily infect and reproduce in E. coli, the main workhorse of genetic engineers, which makes them relatively easy to work with; and, clonal colonies can be isolated easily, merely by “streaking” them at low concentration across an agar plate with a bacterial “lawn”, as described above, and then collecting phages from a single plaque that has become visible as a small and circular clear spot, on the bacterial lawn.

During the 1980's, as more molecular biologists used and tweaked various types of phages, certain types of “filamentous phages” (abbreviated as “Ff” phages). They are called filamentous because they are contained in long and flexible tubular capsids, typically comprising about 2700 to 2800 copies of the “major coat protein” (also known as coat protein pVIII), with about 5 to 10 copies each of two additional proteins (including protein pIII) near their ends.

Filamentous phages emerged as highly useful in genetic engineering, because of an unusual property. Fragments of DNA can be inserted into certain specific sites in their genome (these insertion sites can be easily targeted and manipulated, using “restriction endonuclease” enzymes), and the resulting modified phages will display a protein sequence, encoded by the foreign DNA, in an exposed and accessible manner on the surfaces of the viral capsids. However, despite the presence of a foreign protein sequence in the viral capsid, the engineered phages usually remained fully capable of reproducing, if allowed to invade and “feed on” a colony of E. coli cells.

Accordingly, filamentous phages were widely shared among research labs, and researchers began developing modified strains with even more useful genes and traits. As just one example, a widely used strain, designated as the M13 strain, was given a selectable marker gene that will enable E. coli cells to grow in the presence of an antibiotic called kanamycin. This gene, which encodes an enzyme that breaks apart kanamycin molecules, allows for simple screening of huge numbers of E. coli cells that have been contacted by M13 phages, by using agar plates containing kanamycin to quickly identify and isolate clonal colonies of cells that were transformed by phages.

Numerous articles and book chapters have been published, describing how to work with phages. Fairly recent review articles include, for example, Koivunen et al 1999, Cabilly 1999, Larocca et al 1999, 2001, and 2002, and Manoutcharian et al 2002.

After the useful traits of certain strains of phages were recognized, and after those strains were made available to numerous research teams, researchers figured out how to use those traits for even more purposes. For example, during the 1980's, a number of research teams had been creating highly diverse DNA libraries (involving multiple billions of different sequences). Some of these libraries contained essentially random oligonucleotide sequences (for a review, see Shusta et al 1999), while others contained sequences obtained from immune cells that encoded the “variable binding fragments” of millions of different antibodies (for a review, see Rader 2001). These DNA libraries were being tested in a number of ways (including efforts that involved screening of the libraries) in the hope of discovering sequences that could effectively achieve a known useful function, or sequences that performed previously unknown functions that might offer useful clues to biological or medical processes or treatments.

The researchers who had been creating those types of diverse DNA libraries realized that filamentous phages such as the M13 strain offered a set of useful tools that could enable them to do things that previously had not been possible or practical, so they began inserting their DNA libraries into phages, to create collections that were called “phage display libraries”. These are described in articles such as Scott and Smith 1990, Dower et al 1990; and Devlin et al 1990. An excellent recent review is also available, in Shusta et al 1999.

In addition, numerous patents have been published, in the US and elsewhere, on various specific types of phage display libraries (most commonly on phage display libraries that show promise in killing cancer cells, or in treating autoimmune diseases), and on various tricks and techniques that can be used to render phage display libraries even more useful. Examples of such patent publications include U.S. Pat. No. 5,977,322 (Marks et al 1999), U.S. Pat. No. 6,113,898 (Anderson et al 2000), and U.S. Pat. No. 6,376,170 (Burton et al 2002), and PCT applications WO 2000-29004 (Plaksin), 2000-38515 (Ferrone), and 2000-39580 (Christopherson et al).

Cyclic Screening of Phage Display Libraries in the Prior Art

In some of the very large and extremely diverse DNA libraries that have been created, the huge numbers of variants involved are highly likely to allow a substantial degree of affinity binding, by at least some members of the library, to nearly any type of foreign protein (this is especially true, when the libraries were derived from DNA sequences that encode antibody fragments or T-cell receptors, since these collections are derived from natural sources that evolved in ways that selected for this particular trait). This can allow certain particular phages to be selected because they happen to have a desired binding activity. These selected phages can then be reproduced, enriched, isolated, fully sequenced, or treated in any other desired manner.

Various different types of selection processes can be used, to identify and isolate particular phages that have a desired binding activity. In one fairly common approach, a phage display library, suspended in cell culture solution, is passed through an affinity column which contains antigens, receptor fragments, or other molecules that are of interest. These molecules usually will be trapped and held (immobilized) inside the column, by bonding them to the surfaces of tiny beads. The phages that do not bind to the immobilized molecules of interest will simply pass through the column fairly rapidly, and they will be discarded, while phages that have bound to the molecules of interest will remain inside the column.

After an entire phage display library has been passed through the column, under gentle binding conditions that allow bound phage particles to remain inside the column, a different liquid is then passed through the column. This “elution” liquid typically will contain a higher concentration of salt or acidity (salt, acidity, and elevated temperatures will all cause affinity binding reactions to weaken), and will therefore cause any bound phage that had been bound to immobilized antigens or receptor fragments, inside the column, to be released from the immobilized molecules inside the affinity column.

The phage that emerge from the column only under elution conditions (such as elevated salt, acidity, and/or temperature) will be collected, and they can be reproduced and analyzed in any way desired. As one example, an entire batch of eluted phages can be collectively reproduced (in bacteria) without distinguishing between them, and the next generation of phages can be passed through the same affinity column, using more stringent binding conditions (such as higher salt or acid content during the binding stage, when the cell culture solution is passed through the column, before aggressive elution conditions are commenced). In effect, this cyclical process will initially select an “enriched” population of phages, and it will then use that enriched population to select an “elite” population that will bind tightly to the immobilized molecules in the affinity column.

This type of cycle can be repeated any number of desired times, and when the researchers decide to quit repeating the cycle and study the “elite” phages that showed the tightest binding reactions, they can identify the exact DNA sequences that are being carried by each of those “winning” phages, and the exact amino acid sequences that are encoded by those particular DNA sequences.

In this manner, researchers can use phage display libraries and cyclical screening methods to identify and generate protein sequences that can effectively recognize and bind, with high specificity, to almost any molecular shape (e.g., Barbas et al 2001).

The procedures summarized above can allow the identification of particular phages (from a large and diverse phage display library) that display amino acid sequences that will bind to certain molecules of interest. However, those types of procedures are not enough to enable the identification and selection of particular phages that can trigger and then drive the process of endocytosis (i.e., active transport of selected phage particles into cells, via endocytotic receptors). The challenges of selecting and identifying phages that can drive endocytosis, in living cells, are substantially more difficult than the problems of merely selecting phages that will be immobilized inside an affinity column.

Since those problems are highly important to this invention, they will be discussed below, after one more set of tools is briefly described.

Phagemids and Helper Phages

To complete this brief overview of a remarkable set of tools that were developed over a span of roughly 15 years, “phagemids” need to be introduced.

In order to make phages more adaptable, and capable of carrying larger foreign gene inserts, researchers figured out how to insert a bacterial origin of replication (which can be found in any bacterial plasmid that can replicate itself, inside bacteria), into a phage genome. This allowed the resulting “phagemids” to be propagated in bacteria (usually in the form of double-stranded plasmids), while maintaining expression of any desired proteins, but without producing phage particles (i.e., complete viruses).

After a number of initial types of phagemids had been created and shared, other researchers began figuring out ways to enhance that system even more, by using “helper” phages. This system allows phagemids to be trimmed down and cut down, until they can now contain as little as (i) one capsid gene, which encodes a chimeric protein that must contain the “packaging signal” for that capsid protein; (ii) a bacterial origin of replication, which is necessary to make multiple copies of the phagemid, inside bacteria; and, (iii) a phage origin of replication. These phagemids usually cannot not generate infective phage particles, because they are missing other essential parts of the phage. However, if “helper” phages that contain the missing parts are added to the bacterial culture, then the helper phages can “rescue” the phagemid vectors, by: (i) activating the phage origin of replication, which would (ii) trigger the synthesis of single-stranded phagemid DNA, which would (iii) be incorporated into newly formed phage particles.

These types of options are described in more detail in Example 1, below, which describes how a helper phage strain known as M13KO7 interacts with phagemids in a library that is called the scFv library.

Phagemids that use this approach (i.e., that can use helper phages to provide certain missing elements) offer a number of useful advantages. Two advantages in particular are worth noting. First, phagemids can be handled, manipulated, and reproduced in various ways that cannot be achieved by phages. As just one example, most types of M13-derived phagemids will reproduce in high numbers as double-stranded plasmids and will also make large numbers of coat proteins, while inside E. coli cells, since they cannot go anywhere else. Since they cannot escape from E. coli cells without assistance from a helper phage, they just keep working away inside the host cells, making more coat proteins, and more copies of the phagemid DNA as dsDNA plasmids. Then, when helper phages are finally added, the accumulated quantities of phage DNA and coat proteins inside the cells enable rapid replication and secretion of complete phage particles.

A second major advantage is this: phagemids can often carry and display larger foreign polypeptides, in their coat proteins, than can be carried by phages that must carry everything they need on their own. This is analogous to enabling someone to lift and carry a heavier load, if he is not also required to carry a full set of luggage at the same time.

This completes a very brief overview of phages, phagemids, and phage display libraries.

Selection of Phages that can Activate and Drive Internalization

As briefly mentioned above, some difficult problems arise, when researchers try to push the selection of phage display libraries beyond a level of simply binding to immobilized molecules in affinity columns, and into the realm of active endocytosis and uptake into cell interiors.

For the most part, these problems center on two factors: (i) multiple different phages will usually bind to multiple different proteins and other molecules, on the surfaces of cells, without being taken into the cells; and, (ii) it is very difficult to rinse off, wash off, or otherwise reliably remove any and all phages that are clinging to the surfaces of cells, and that have not been taken inside the cells, without killing and lysing the cells or otherwise creating severe problems that will interfere with other desired processing of the cells and/or internalized phages.

Because of these two factors, it is very difficult to prevent “false positives” from being selected, during efforts to identify endocytotic ligands by screening a phage display library.

In addition, because of the two problematic factors listed above, the screening of phage display libraries, in efforts to identify and select endocytotic ligands, is almost always limited to cell culture tests. This type of endeavor is technically very challenging, difficult, tedious, and plagued with false positives.

Those problems apply to even the simplest tissue culture systems, where all of the cells can be clonal duplicates and have exactly the same receptor types. The notion of attempting to carry out phage library screening tests in an intact and still-living animal (where multiple different tissue and cell types, each with their own specialized set of receptors and other surface molecules, must coexist in close contact with each other, and with blood and lymph constantly circulating through and between the different tissues regions and cell types) simply is not within the mindset of ordinary artisans who are skilled and practiced in the art of phage library screenings, and who understand the considerable difficulties of doing it successfully even in the simplest cell culture conditions.

An understanding of the obstacles involved in carrying out in vivo endocytotic screening of phage display libraries can help explain why so much work has been done with phage display libraries for developing potential treatments for cancer and autoimmune diseases, and why so little work has been done on using phage display libraries in vivo, or applied to neurons. One of the distinguishing traits of cancer cells is that they can grow, without limits, in in vitro cell culture solutions. Therefore, phage display libraries can be tested, fairly easily, for endocytotic uptake into cancer cells and/or tumors, by simply using cancerous cells that are growing in in vitro tissue culture. In this manner, the formidable problems that face in vivo selection of endocytotic phages can be simply avoided, and bypassed.

Similarly, most types of cells that are involved in autoimmune diseases can also be studied and tested quite effectively, in in vitro cell culture conditions. Unlike neurons (which are technically very challenging and difficult to grow in vitro, in a way that can reasonably emulate neurons in a brain or spinal cord, because of the complex dependencies of neurons on multiple types of glial cells, and on innervation by nerve impulses from other neurons), most types of cells that are important in autoimmune diseases are generally classified as “white blood cells”, and are comparatively easy to grow in vitro. These cells normally float freely, in blood or lymph fluids, inside the body. Therefore, they can be treated and tested in in vitro cell culture solutions that mimic the blood and lymph fluids in the body (indeed, these cell culture fluids often contain components of actual blood, such as “fetal calf serum”, a widely used additive for cell culture liquids, abbreviated as FCS).

Accordingly, there have been many efforts, and much progress, in using phage display libraries to develop improved genetic engineering methods and vectors that can be used to genetically transform and treat cancers, and autoimmune diseases.

By contrast, there have been few efforts and only very paltry and limited progress, in using phage display libraries to treat other diseases, or to create genetic vectors that can enable the transformation of neurons and other cells that are present in cohesive tissue, inside the body. Under the prior art, the challenges and difficulties of eliminating false positives, when phage display libraries are screened for endocytotic uptake into neurons and other cohesive tissue cells in intact animals, in in vivo tests, have been so severe, and so formidable, that they have effectively blocked and prevented any substantial progress in that field of research.

Prior to this invention, no one had figured out how to make practical use of phage display libraries, to accomplish the results that can now be achieved by this invention. Prior to this invention, physicians who wished to use gene therapy to treat severe medical problems were more or less stuck with viral vectors, despite the major problems and shortcomings that plague viral vectors, because non-viral vectors simply have not reached a level of efficacy that can approach the efficacy of viral vectors, in delivering foreign genetic material into targeted cells.

Accordingly, one object of this invention is to disclose new and practical in vivo methods for identifying and isolating ligand molecules that can be used to effectively transport other molecules (including “passenger” or “payload” molecules that will create a useful and desired effect) into selected, targeted, and limited types and classes of animal cells.

Another object of this invention is to disclose a new method for identifying and isolating ligand molecules that can be used to effectively transport therapeutic drugs, diagnostic or analytical compounds, or DNA sequences, into selected, targeted, and limited types and classes of animal cells.

Another object of this invention is to disclose a new method for in vivo screening of libraries, repertoires, or other assortments containing multiple candidate polypeptides or other compounds that have been created by combinatorial chemistry, to identify and isolate those particular candidates that undergo endocytotic transport into cells.

Another object of this invention is to disclose and provide new ligands, for use in non-viral genetic vectors, that can substantially increase the ability of non-viral vectors to transform neurons, as one particular class of targeted cells.

Another object of this invention is to disclose and provide methods for identifying and isolating new ligands that can be used to transport therapeutic, diagnostic, or other useful compounds into specific targeted internal organs or other types of targeted cohesive tissues.

Another object of this invention is to disclose and provide new molecules that bind to known neuronal receptors (such as p75 receptors, in humans or other mammals) and that can stimulate internalisation by those neurons in in vivo gene therapy treatments.

These and other objects of the invention will become more apparent through the following summary, drawings, and description.

### SUMMARY OF THE INVENTION

An in vivo screening process is disclosed, which can identify and isolate ligand molecules that can activate and drive ligand-mediated endocytosis (internalisation) of molecules into mammalian cells. These ligands can provide efficient transport of “passenger” or “payload” molecules (such as therapeutic drugs, diagnostic or analytical compounds, or non-viral genetic vectors) into specifically targeted classes of cells.

This in vivo screening process involves placement of an assortment of candidate ligands, in a suitable form (such as a bacteriophage display library) inside the body of a rat or other animal, in a location where the candidate ligands will contact nerve fibers (such as a sciatic nerve bundle, in a rat leg). In a preferred embodiment, a ligature loop is also tightened around the same nerve fibers at a different location, such as near the animal's hip. A period of time is allowed to pass, to enable ligands that bind to endocytotic receptors on the nerve fibers to be internalised. After entry into the nerve fibers, internalised ligands will be transported through the fibers in a retrograde direction (i.e., toward the spinal cord), by axonal transport. The animal is sacrificed, and a segment of nerve fibers is harvested (such as immediately adjacent to the hip ligature) that will contain the internalised ligands. The internalised ligands are collected from the harvested nerve fiber segments, and treated in any desired manner (such as by reproducing and analyzing the phage particles that carried internalised polypeptide sequences). Since nerve fiber segments are harvested from a site that is located a distance away from the ligand placement site, the ligands that actually undergo endocytotic uptake and axonal transport are separated from the other candidate ligands that did not enter the nerve fibers. In this way, false positives are avoided or minimized.

This in vivo screening method can be combined with other known genetic engineering methods, in various ways. As one example, rats or mice can be genetically transformed by chimeric genes, in ways that will cause the animals to express, on the surfaces of neuronal fibers that extend outside the blood-brain barrier (including but not limited to sciatic nerve fibers), selected types of endocytotic receptors (including human receptors, if desired) that normally are not present on the surfaces of such nerve fibers in rats or mice. This can be accomplished in any of several ways, such as: (i) creating transgenic animals which carry the foreign genes in their chromosomes, or (ii) using genetic vectors to insert new genes directly into sciatic nerve fibers, in a manner that will lead to either permanent or transient expression of those genes by the transfected neurons. The screening method disclosed herein can then be used, in the genetically transformed rats or mice, to identify ligands that are internalised by the transgenic receptors on the surfaces of the rat or mouse sciatic nerves. The ligands that are identified and selected by this method can then be tested in human or other cells, in in vitro tests (followed by in vivo clinical trials, if desired) to confirm that they can and will function effectively to transport passenger/payload molecules into targeted organs or cell types, for medical, diagnostic, or other purposes.

Similarly, this screening method can be adapted in various ways for use with combinatorial chemical synthesis. This can enable, for example, improved in vivo screening of candidate ligand compounds that are not polypeptides.

In addition, since expression of certain types of neuronal receptors (such as the low-affinity p75 nerve growth factor receptor) on sciatic nerve fibers can be increased by inflicting a controlled injury on a sciatic nerve bundle, the placement of receptor-encoding gene sequences under the control of such inducible gene promoters can render this method easier to perform and validate. This invention has clearly proven that ligands which can recognize and bind to the p75 nerve growth factor receptor can indeed be used to target the delivery of passenger/payload molecules, such as proteins and DNA, into targeted neurons, in vivo.

Accordingly, this invention discloses new methods for identifying, isolating, and analyzing endocytotic ligands, and for creating gene sequences, non-viral genetic vectors, and molecular complexes that transport therapeutic, diagnostic, or other useful molecules into mammalian cells. It also discloses molecular complexes which include an endocytotic ligand component identified by this method, coupled to a passenger/payload molecule that can exert a desired effect after it has been transported inside a targeted class of cells having endocytotic surface molecules to which the ligand component will bind.

### BRIEF DESCRIPTION OF THE DRAWINGS

FIG. 1 is a schematic display of the two ligatures that were emplaced around a sciatic nerve bundle in a rat, and of the phage-containing collagen gel that was emplaced in direct contact with the cut end of a sciatic nerve bundle, in a manner that enabled endocytotic uptake of phages into the nerve cells.

FIG. 2 is a photograph of fluorescent-labelled antibody-phage conjugates that accumulated within a sciatic nerve bundle, next to a hip ligature. The ligature (a loop of tightened suture material) prevented those antibody-phage conjugates, which had been internalised by the sciatic nerve fibers, from being retrogradely transported beyond the ligature constriction site.

FIG. 3 schematically depicts a cyclic in vivo ligand selection process, in which ligand-displaying phages from a phage display library are selected for endocytotic uptake into nerve fibers, by the in vivo method disclosed herein, and wherein the selected phage population that results from one cycle is used as the starting material for screening in the next cycle.

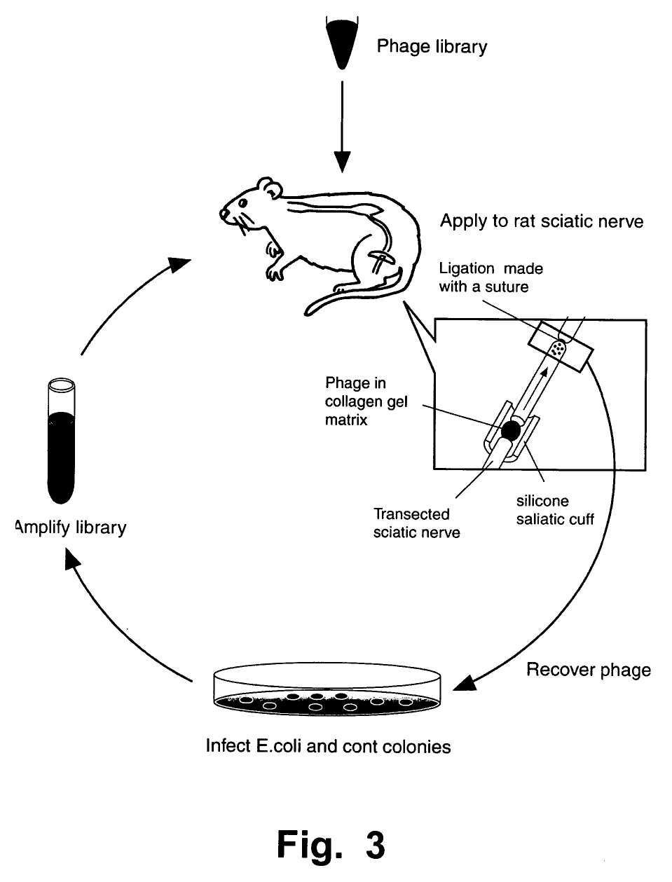

### DETAILED DESCRIPTION

As summarized above, the in vivo screening process disclosed herein involves placement of an assortment of candidate ligands (in a suitable form, such as a bacteriophage display library), inside the body of a rat or other animal, in a location where the candidate ligands will contact nerve fibers.

In a preferred embodiment, this in vivo screening process can use the sciatic nerves of rodents, such as rats or mice. Both of these species are inexpensive and easy to breed and raise, and they have become the standard animal models used in most genetic research in small mammals. A huge foundation of information, species-specific biomolecules (including gene promoter sequences, gene coding sequences, monoclonal antibodies, etc.) and specialized animal strains, have been developed for genetic work with mice, and gateways that can be used to access that information are freely available on websites such as www.informatics.jax.org and www.ncbi.nlm.nih.gov/genome/seq/MmHome.html. Although the corresponding information, reagents, and strains for rat genetics are somewhat less, they are still enormous and quite useful, and can be accessed through websites such as http://rgd.mcw.edu, http://ratmap.gen.gu.se, and www.hgsc.bcm.tmc.edu/projects/rat.

Because of the larger size of rats, it is easier to work with their sciatic nerves (which pass, on each side of the animal, from the spinal cord, through one hip and leg, down to the foot) than with mice. This can be done by known methods, such as discussed below.

However, even in mice, the sciatic nerves are long enough and sufficiently distinct to enable the required surgical manipulations, using the procedures disclosed herein (especially if such manipulations are carried out by researchers who have done such work before). In addition, it should be kept in mind that surgical manipulations in mice can be done with the aid of binocular microscopes, and surgical tools that are commonly used by ophthalmologic surgeons and neurosurgeons. Additional comments on and surgical methods are contained in Example 4, below.

It should also be noted that other types of laboratory animals (which may include primates, non-mammalian vertebrates, or even some types of invertebrates) can also be evaluated for potential use in this type of in vivo screening, if desired. In particular, some animals are known to have exceptionally large neuronal axons; as one example, some types of squids have a “giant axon” that controls the muscles that drive propulsion. In the same way that Chinese hamster ovary (CHO) cells became widely used in research laboratories because they contain unusually large cell components, squids or other animals that have unusually large nerve fibers or bundles can be used as disclosed herein, if desired.

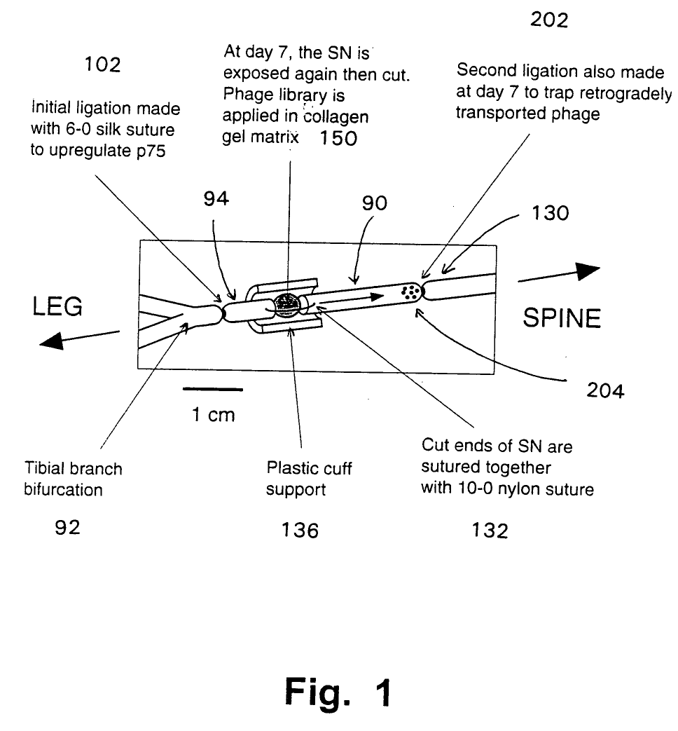

The placement of candidate ligands in contact with a sciatic nerve bundle can be done in a manner that is schematically illustrated in FIG. 1, and discussed in more detail in Examples 4 and 5, below. Briefly, if an inducible receptor (such as the low-affinity p75 nerve growth factor receptor) is going to be targeted, a first ligature 102 is emplaced and then tightened around the sciatic nerve bundle 90. This ligature 102 is created by placing a strand of suture material around the nerve bundle, and then tightening the loop and tying it off, in a manner that creates a constriction that acts as a tourniquet, by hindering the normal flow of fluids and molecules inside the nerve fiber.

As shown in FIG. 1, ligature 102 can be placed adjacent to the “tibial branch bifurcation” 92, where the sciatic nerve bundle 90 divides into two major branches, which serve different parts of the leg and foot. Ligature 102 preferably should be placed above, and fairly close to, the tibial branch bifurcation 92. As mentioned in the Background section, the terms “above” and “proximal” indicate a location closer to the animal's spinal cord (toward the right side of the drawing shown in FIG. 1). By contrast, the terms below and distal indicate a location farther away from the spinal cord, and closer to the leg or foot (toward the left side of the drawing in FIG. 1).

The purpose of ligature 102 is to increase the number of p75 receptors that will be expressed on the surfaces of the sciatic nerve bundle. The p75 receptor interacts with certain neurotrophic factors (also called nerve growth factors) which are polypeptides that have hormone-like effects on nerve cells. The best known such molecule was called nerve growth factor, since it was discovered fairly early in the process; as additional such molecules were discovered, they were given names such as brain-derived neurotrophic factor (BDNF), neurotrophin-3, and neurotrophin-4/5. The neurotrophins effectively stimulate neurons in ways that generally lead to increased metabolic activities, the formation of additional synaptic connections with other neurons, etc. If a neuronal fiber of a motor neuron is injured or distressed, one of the ways the motor neuron responds is by increasing the number of p75 receptors on its neuronal fiber, which may give it a better chance to grab and bind any nerve growth factor molecules that happen to be in the surrounding extracellular liquids. This process of “upregulating” certain types of neuronal receptors on the surfaces of nerve fibers has been discovered and shown to occur in certain neurodegenerative diseases, notably including amyotrophic lateral sclerosis, also called ALS, Lou Gehrig's disease, and motor neuron disease. It also occurs after various types of trauma.

Accordingly, ligature 102 is designed to exploit that type of neuronal response. By emplacing and tightening a loop of suture material around the nerve fiber, in a manner which creates a tourniquet that blocks the flow of fluids through the fiber, it is possible to increase the number of p75 receptors along the length of the nerve fiber, between the spinal cord and the ligature site. Based on various tests, including staining tests that use monoclonal antibodies that bind to p75 receptors, the increase in p75 receptors is estimated to be about 10 to 15-fold.

This receptor expression response, by a nerve fiber, to a constrictive ligature, occurs over a span of roughly a week. Therefore, after ligature 102 is placed and tightened around the sciatic nerve bundle, the wound should be closed and sutured, and the animal should be allowed to recover, for at least several days and preferably for about a week, before the next surgical procedure is performed.

During the second procedure, two different sites will be surgically opened, roughly 2 to 3 centimeters apart from each other. One site will be close to the same site where the ligature 102 was placed; indeed, the surgical opening can be located at the same site as before. At this site, the sciatic nerve bundle is cut (i.e., transected), by using a scalpel or scissors, in a manner that generates two ends (which can be blunt, angled, etc.). The cuts are made just above and below ligature 102, and a small portion of the nerve bundle which contains the ligature can be excised and discarded. These cuts will create two ends of the nerve bundle, designated as distal end 94 (which will no longer be active), and proximal end 130 (on the side that is toward the spinal cord).

At the site where the sciatic nerve bundle 90 is cut, a bolus of material 150 is emplaced. This bolus 150 is made a porous and permeable material (such as a collagen gel) that contains a large number of phage particles (preferably in the millions or billions of “colony forming units” (cfu)). This bolus 150 should be emplaced and secured at this site, in a manner that will promote sustained intimate contact between (i) the phage particles that are contained in bolus 150, and (ii) the cut end 130 of the sciatic nerve bundle 90. This type of emplacing and securing can be done by means such as:

(a) using a strand of suture material 132 to tie together the two cut ends 94 (i.e., the distal cut end) and 130 (i.e., the proximal cut end) of the sciatic nerve bundle 90; and,

(b) wrapping and securing a small sleeve or cuff 136, made of a watertight material such as silicone rubber, around bolus 150 and around the two ends 94 and 130 of the sciatic nerve 90, in a manner which encloses the bolus and the two nerve ends inside a small watertight cylindrical volume. If desired, the sleeve 136 can be secured by wrapping and tying one or more suture strands around it, by placing a droplet or bead of adhesive material on the outer surface of the sleeve, or by any other suitable means.

Accordingly, this site, where the bolus of material containing phage particles is emplaced, can be referred to as either the phage placement site, or the phage contact site. This is the location where the library or repertoire of phage particles will contact the cut end of the sciatic nerve. Phage particles that happen to display, on their surfaces, polypeptide sequences that will trigger endocytosis (such as through a p75 receptor on the surface of a nerve fiber) can be internalized by the nerve fibers, at this site.

At a separate and distinct site, preferably located roughly a centimeter or more away from the phage placement site, a second site is surgically opened, and a second ligature 202 (formed by a loop of suture material) is emplaced and then tightened and tied around the sciatic nerve bundle. Since the rat hip offers a convenient location, far enough away from the phage placement site to eliminate any significant risk of false positives caused by phages clinging to the outsides of sciatic nerve fibers, this site preferably should be in the hip region, and it is referred to herein as the hip ligature site. The hip ligature 202 will act as a constriction or tourniquet around the sciatic nerve bundle 90, and must be tight enough to substantially hinder the travel of fluids or molecules, inside the nerve fibers, across that blockage point. Accordingly, this constriction will generate a phage accumulation zone 204, inside the nerve bundle and distal to the hip ligature 202.

The rat wounds are closed and sutured, and a suitable span of time (such as about 18 hours) is allowed to pass, to give phage particles that happen to be carrying ligands that can effectively activate and drive the process of endocytosis, enough time to enter the nerve fibers, and then be retrogradely transported through a significant length of the nerve fibers, toward the spinal cord).

After that span of time has passed, the rat is painlessly sacrificed, the site of the hip ligature is opened, and a segment of the sciatic nerve bundle immediately adjacent and distal to the hip ligature is removed (harvested). This short bundle of nerve fibers is then divided into small pieces, and processed using chemicals that will partially digest cell membranes (which are made of lipid bilayers) without damaging the phage particles. This processing allows the collection and isolation of viable phage particles that had been internalised into the nerve fibers.

The phage particles that are selected by a round of in vivo screening as disclosed above can be reproduced and/or manipulated in any way desired. As examples, any and all of the following procedures can be carried out, using phage populations selected by the in vivo screening process disclosed herein:

(1) if the phages are “phagemids” (which merely requires the phage to contain a bacterial origin of replication), they can be amplified (reproduced), by using E. coli cells without helper phages, in ways that will generate double-stranded DNA in plasmid form. It should be noted that nearly all modern phage display libraries use phagemids, since they enable various useful procedures, including the synthesis of circular plasmid DNA in any desired quantity. All phage display libraries used herein were phagemid libraries.

(2) by using E. coli cells plus helper phages, the selected phages can be amplified in ways that generate new and fully infective phage particles containing ssDNA. These phage particles can be used as the starting reagents in another cycle of in vivo screening, which (during the early cycles) can be used to refine an “enriched” population of endocytotic phages into an “elite” population that is likely to contain ligands that are even more effective at triggering and driving endocytosis.

(3) when enough selection cycles have been completed to suggest that a suitable point for phage analysis has been reached (in most cases, this is likely to happen after at least one, up to about three cycles of screening, or possibly more in some cases), the phages selected by the last round of in vivo screening (or, indeed, by any round of in vivo screening) can be used to create either or both of the following: (i) any desired quantity of double-stranded or single-stranded DNA, for nucleotide sequencing to determine the exact sequence of the gene that encoded a particular endocytotic ligand; and/or, (ii) any desired quantity of the coat protein which carries an endocytotic ligand, in a soluble form that can be processed and sequenced, to determine the amino acid sequence of the ligand domain in that particular coat protein.

Photographic Confirmation of In Vivo Screening Results

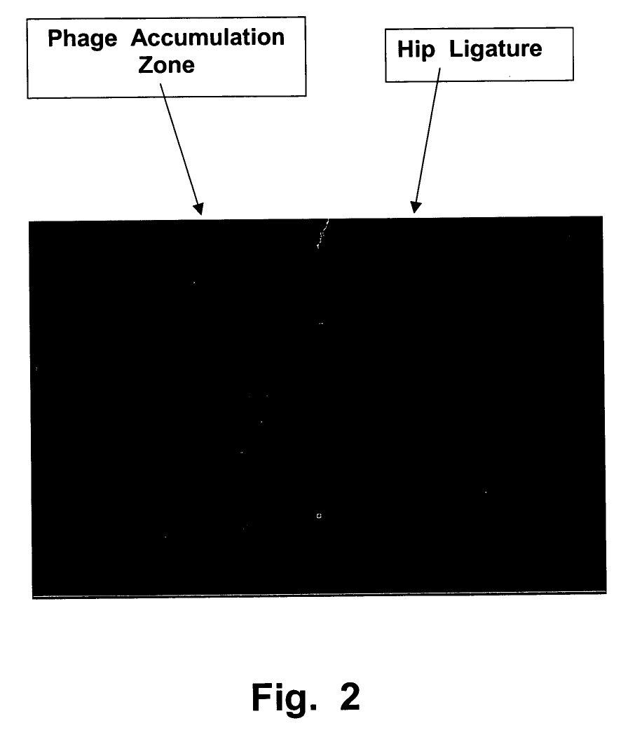

The efficacy and success of the in vivo screening process disclosed herein is depicted, visually, by the photograph in FIG. 2. This photograph was created during an actual test of this in vivo selection process, using fluorescent reagents to indicate the locations and concentrations of phages that were internalised within the sciatic nerve bundle (the phage preparation and staining reagents that were used in this test are described in Example 6, below). The left side of the photograph in FIG. 2 shows fairly high concentrations of fluorescent-labelled phages, in the nerve portion that corresponds to phage accumulation zone 204 as shown in FIG. 1. The choked and narrow zone in the center of the photograph was created by the hip ligature 202. The right side of the photograph shows the sciatic nerve on the proximal side of the hip ligature (i.e., in the direction of the spinal cord). Since very few or no phages were able to squeeze past the hip ligature 202 and reach that part of the sciatic nerve, it shows almost no fluorescent labelling.

Use of In Vivo Screening with Combinatorial Chemistry

The general approach disclosed herein, for in vivo screening and identification of endocytotic ligands, can be adapted for use with candidate ligand molecules created by “combinatorial” chemical synthesis. Over the past 20 years, this branch of chemical synthesis and screening has become a highly active field, and an April 2003 search of the National Library of Medicine database revealed more than 900 review articles on this field of research. Recent review articles include Lockhoff et al 2002, Flynn et al 2002, Edwards et al 2002, Ramstrom et al 2002, Ley et al 2002, Lepre et al 2002, Liu et al 2003, Edwards 2003, and Geysen et al 2003. The synthesis methods and approaches described in those review articles can be used to provide a wide range of highly diverse combinatorial libraries.

One of the essential traits of any such combinatorial library is that it must be adaptable to at least one or more types of screening tests. Otherwise, a mixture of thousands or millions of different candidates would be totally worthless, since no one would be able to tell which particular compounds, in the mixture of thousands or millions of candidates, would be useful for some particular purpose.

Therefore, any type of combinatorial library will be created in a manner that provides the candidate compounds with some type of “handle” that can be used to identify or manipulate the candidates (or that can identify or manipulate those particular compounds that were modified, isolated, or otherwise distinguished by a reaction or screening process) in one or more useful ways.

A fairly generous variety of these types of “handles” are known, and the variety of known approaches will enable at least one and usually more of these “handles” to be adapted to in vivo screening of combinatorial libraries, using nerve fiber manipulations as disclosed herein. As examples, well-known classes of “handle” approaches that can be used to process and control combinatorial chemistry repertoires can include any and all of the following:

1. microscopic beads, tubes, or other solid surfaces, usually made of a plastic, starch, or similar compound. These beads or other solid surfaces usually serve as a substrate or “anchor”, and provide (on their surfaces) reactive groups that will become attachment points for chemical chains that will be added to those reactive groups. If desired, these types of microscopic beads can be created with diameters that are well suited for phagocytotic intake by mammalian cells.

2. special reactive moieties that occur only once in each candidate compound in a combinatorial library. These unique reactive moieties can be used to enable attachments, chemical reactions, or other manipulations, that can be used at any stage during or after a screening process is carried out, to precipitate, condense, or otherwise gather, isolate, conjugate, label, or manipulate particular candidate compounds that were transported to a target location, or that became involved in a chemical or cellular reaction of interest, or that otherwise acted differently from the unsuccessful candidates, during a screening test.

3. non-toxic fluorescent “labels” or “tags” that will emit light at one wavelength, when excited by light having a different wavelength. This enables the use of equipment called “flow cytometers” (also called cell sorters, and similar terms), to segregate cells or particles that have fluorescent activity. In a typical flow cytometer with sorting capability, millions of cells or particles can be passed through a narrow tube, one at a time, at a known and controlled velocity. At one location in the pathway, each cell or particle passes through a light with an excitatory wavelength. Individual cells or particles that contain or are attached to a fluorescent label or tag will respond by emitting light at the different wavelength. This fluorescence, which occurs within nanoseconds, is detected by an optical sensor which is tuned to the fluorescent wavelength. When that optical sensor detects fluorescent light emitted by a certain cell or particle, it triggers a tiny jet of gas or liquid, at a location slightly downstream in the flow path of the cells or particles. That jet of gas or liquid is timed to coincide with the passage of the fluorescent cell or particle, through a junction in the pathway. If the jet of gas or liquid pushes a fluorescent cell or particle to one side, in the flow path, it will enter a separate collection tube, which will carry it to a collection vessel. In this way, a flow cytometer can process millions of cells or particles within a span of hours or even minutes, and it can isolate even a single individual fluorescent cell or particle, out of a population of millions.

4. other types of labels or tags, such as compounds that include radioactive isotopes, or specialized molecular structures that can be located and tracked by sophisticated analytical methods such as magnetic resonance imaging, Raman scattering, etc.

5. whenever an assortment of candidate ligands includes or involve polypeptides, phage display libraries offer exceptionally powerful, flexible, and adaptable “handle” systems for working with such polypeptides. If even a single phage particle is isolated which carries a highly effective and potentially useful ligand polypeptide, then that single phage particle can be grown rapidly into an entire clonal colony, which can provide an unlimited supply of both the polypeptide, and the gene which encodes that polypeptide, using procedures as described herein or as otherwise known to those skilled in the art.

Indeed, the PhD-C7C phage display library offers an example of a combinatorial approach that has been adapted for use with polypeptides. In this library, essentially random segments of short polypeptides, seven amino acids long, were created by combinatorial chemistry. These randomly-created short polypeptide sequences were incorporated into phage particles, and those phage particles provide the “handles” which can be used to manipulate, reproduce, and screen the combinatorial assortment of polypeptides in the PhD-C7C library.

As mentioned above, any combinatorial library must necessarily be created in a manner that will render it susceptible to at least one type of system or mechanism that enables researchers to handle and manipulate the candidate compounds in the library. Otherwise, it would be useless to generate such libraries, if they could not be screened by effective and logical methods. Therefore, the range and variety of methods that have been developed over the past 20 years, for screening combinatorial libraries, have become quite sophisticated and powerful. Accordingly, the in vivo screening methods disclosed herein can be regarded as merely providing one more new (and potentially powerful, and useful) method for screening candidate compounds that have been created by combinatorial chemistry.

Genetic Engineering Methods to Extend In Vivo Screening to Other Receptors, Other Species, and Other Classes of Neurons

Those skilled in certain related arts will recognize various ways in which this invention, initially developed and tested using the motor neurons of the sciatic nerve in rats, can be expanded and extended in several particular directions that will be of interest to research, physicians, and others.

As one example, those skilled in neuroanatomy and neuronal tracing studies will recognize ways in which this invention can be expanded beyond sciatic motor neurons, to enable its use: (i) with sympathetic processes emanating from the superior cervical ganglion and sensory processes emanating from the trigeminal ganglion sensory nerves, following injection of phage libraries into the anterior eye chamber; (ii) with olfactory receptor sensory neurons (harvesting olfactory bulb tissue), trigeminal ganglion sensory and superior cervical ganglion sympathetic nerves, following administration of test libraries into the nasal cavity; (iii) with retinal ganglion cell sensory neurons, following injection into the posterior chamber of the eye; and, (iv) with various neurons of the central nervous system, following injection into the lateral or other ventricles of the brain. By such means, ligands targeted at endocytotic receptors that are naturally expressed by these particular neuronal populations can be identified and isolated, for use in diagnosing and treating disorders that involve those particular classes of neurons.

Similarly, those skilled in genetic engineering and molecular biology will recognize ways in which this invention, initially developed and tested using p75 receptors in rats, can be expanded and extended to enable its use: (i) with endocytotic receptors other than the p75 receptor; (ii) with endocytotic surface molecules other than receptors; (iii) with endocytotic receptors that are present in species other than just rats, including human receptors; and, (iv) with endocytotic receptors that are present on specific types of cells and tissues other than neurons (such as, for example, receptors that normally are found in significant numbers only on the surfaces of cells in kidneys, livers, lungs, hearts, etc.).

This type of work has been done before in a number of cases, because once the DNA sequence that encodes a particular type of human receptor protein is known, that human gene sequence (or any portion thereof) can be used to transform animals of a different species, such as mice or rats. The genetically transformed animals will then express the human receptor protein, having the exact same human amino acid sequence. As just one example, the human receptor protein that enables polio viruses to infect certain types of motor neurons, in humans and certain other primates, was used to transform mice. This allowed the transformed mice to be used as inexpensive animal models, for studying polio and polioviruses.

In a similar manner, as an example of how that type of genetic engineering can be adapted to enable in vivo screening as disclosed herein, the following series of steps can be carried out, by skilled artisans, using DNA sequences and other reagents and methods that are already known and available in the art:

1. The human homologue of the p75 gene, which has been fully sequenced (Johnson et al 1986) can be placed in a chimeric gene, under the control of the p75 gene promoter normally found in mice or rats;

2. This chimeric (mice or rat promoter/human coding) version of the p75 gene can then be used to genetically transform selected types of mice or rats, such as strains of mice that have a “knockout” mutation which prevents them from properly expressing the p75 receptor; such strains are available from Jackson Laboratories (www.jax.org, or www.jaxmice.jax.org), as stock number 002213 (strain name B6.12954-Ngfr^{tm1Jac}).

3. The transformed mice or rats will express the human version of the p75 receptor protein, and human p75 receptors will appear in the same locations where the rat p75 receptor protein normally exists, including on the surfaces of sciatic nerve fibers that extend outside the blood-brain barrier;

4. A ligand library (such as the scFv phage display library, or the PhD-C7C phage display library) is then screened, using the same procedures disclosed herein, to identify candidate phages that will undergo endocytotic uptake and retrograde transport, through a process that is mediated by binding of the ligand domain of a phage particle to the human version of the p75 receptor.

5. Alternately or additionally, ligands that have been discovered and identified to enter cells through the rat p75 receptor protein can be tested, in vitro, to determine whether they will also enter cells that have human p75 cell receptors (such as on a human neuroblastoma cell line that grows readily in suspension culture and that expresses the natural version of human p75;

6. Alternately or additionally, if the endocytotic efficiency of a ligand that readily enters rat neuronal fibers through rat p75 receptors is tolerable but not very high, when it interacts with human p75 receptors, then that particular ligand can become the starting compound in a process that will (i) use site-directed or random mutagenesis to create numerous analogues of the rat-p75-binding ligand, and (ii) use in vitro screening to identify and evaluate promising analogues that can readily enter cells through human p75 receptors.

These are just a few examples of how the in vivo screening methods disclosed herein can be adapted for use in discovering, isolating, and analyzing ligands that will enable efficient transport of passenger or payload molecules into human cells, for use in human medicine, diagnostics, analysis, and research.

Molecular Complexes and Methods Enabled by this Invention

The true value of the screening methods disclosed herein comes not from the act of identifying particular ligands that can activate and drive endocytotic internalisation, but from the subsequent ability to incorporate and use those selected ligands, in “molecular complexes” that can be used for medical, diagnostic, and similar purposes.

As used herein, the term “molecular complex” refers to a molecular assemblage that includes at least two distinct components: at least one ligand component, and at least one passenger or payload component.

In order to fall with the claims that refer to such ligands or to molecular complexes which include such ligands, a ligand component must meet two criteria, as follows.

First, the ligand component must have been identified by an in vivo selection process as disclosed herein (i.e., to be covered by a claim such as claim 1, the ligand component must have been identified by a process of in vivo selection that required, at a minimum, endocytotic uptake into neuronal fibers, for such selection to occur). This type of identification is an essential step, in the screening methods of invention, and in the molecular complexes that can be formed using ligands that were in fact identified by this method. To illustrate this fact, it can be presumed that a phage library containing billions of candidate ligand polypeptides (such as the scFv library, which was used and screened as described in the Examples) does indeed contain hundreds, thousands, or possibly even millions of phage particles that are indeed carrying candidate ligand sequences that are quite capable of serving as potent, specific, effective endocytotic ligands, which could be used to carry passenger molecules into cells having p75 receptors on their surfaces. However, those hundreds, thousands, or even millions of phage particles which have that theoretical potential, in that huge library, are surrounded by billions of other phages that would be totally useless for that purpose, and that would provoke all kinds of unwanted responses if coupled to passenger molecules and injected into an animal or human that needs medical treatment.

Obviously, the screening and processing steps that are required to identify and isolate those phages which carry ligand sequences having a known and useful endocytotic activity is an absolutely critical step, in creating molecular complexes which can actually accomplish desirable and useful medical, analytical, or similar results.

The second requirement that applies to the ligand components that are used to transport passenger or payload components in molecular complexes, as described and claimed herein, is this: the molecular complex, which includes a ligand component that was initially identified by the in vivo screening process disclosed herein, must be able to actually enter targeted types and classes of cells which have endocytotic surface molecules to which the ligand component will bind. If such a molecular complex cannot enter at least one class of such cells, then that molecular complex is not covered, and is not intended to be covered, by the claims herein.

It should be clear, however, that once a particular ligand has been identified which can enter cells through a particular and targetable class of endocytotic surface molecules (and once the amino acid sequence of that particular ligand is known, if that ligand is a polypeptide), then that particular ligand can be synthesized in any desired quantity, and it can be used as an endocytotic transport system to carry a wide range of useful “passenger” or “payload” molecules into targeted cells. Accordingly, after such a ligand component has been identified by means of the new and powerful in vivo screening methods disclosed herein, then the use of that ligand, as an endocytotic transport component, in molecular complexes that also contain “passenger” or “payload” molecules, is not limited to any one specific type or class of passenger or payload molecule.

The terms “passenger molecule” and “payload molecule” are used interchangeably herein, to refer to the portion of a molecular complex (i.e., containing a ligand as set forth above) that will perform one or more useful functions, or exert one or more useful effects, after the passenger molecule has entered a targeted cell containing an endocytotic surface molecule to which the ligand component will bind. These terms are intended to be construed broadly, and in general, a passenger or payload molecule must be interpreted by recognizing how these same terms are used in other modes of transportation. Cars, buses, trains, airplanes, and bicycles are all useful, because they can carry passengers, at speeds and over distances which simply cannot be achieved, on a practical level, by other means of transportation. Similarly, freight trains, 18-wheelers, and tanker trucks and boats are useful because they can carry freight, which can be regarded as the payload whenever a trip is being made to an intended destination. Cars, buses, trains, airplanes, bicycles, and boats are highly useful and valuable modes of transport, not just because they can carry one particular person to one particular place, but because they can be adapted and used to carry numerous types of passengers or freight to numerous selected and targeted destinations.

Accordingly, passenger or payload molecules, as disclosed and contemplated herein, should be interpreted broadly, and include but are not limited to each of the following major classes:

(1) DNA segments that are part of genetic vectors that are intended to genetically transform animals, or to medically treat humans in need of genetic therapy. Indeed, one of the first and foremost goals of this entire line of research was to identify and create cell-targeting components that could be used to create new classes of genetic vectors that can be used to specifically target and transform only certain particular types of cells, without disrupting the status or activities of other cell types in ways that would greatly increase the risk and severity of unwanted side effects.

(2) therapeutic and/or diagnostic compounds (including pharmaceuticals, imaging compounds, etc.), for use in human or veterinary medicine.

(3) analytical compounds, reagents, and other substances that would be more useful, in industrial research and similar endeavors, if they could be transported efficiently into targeted classes of cells.

Finally, it should also be noted that a molecular complex which contains both a ligand component, and a passenger or payload component, must also have some effective means for coupling and holding those two components together, to form a complex that will hold together at least until the passenger or payload component has been successfully pulled inside a targeted cell. In some cases, depending on the passenger or payload component, it may be possibly to couple the passenger or payload component directly to the ligand component, by means of a direct covalent bond, or by means of a “coordinate” bond (this term refers to a class of molecular bonds having levels of strength and/or stability that fall somewhere between covalent bonds, and ionic attractions). However, if a passenger component is bonded directly to a ligand component, it is likely that this type of molecular complex may not be optimal, for at least some types of intended uses, because it often will be necessary to release the passenger component from the ligand component, after the molecular complex has entered a targeted cell, so that the passenger component can then carry out its intended function without having the ligand component still attached to it. By way of analogy, this is comparable to saying that a car, truck, or bus will be substantially more useful, if is it provided with doors that will allow passengers to leave the vehicle, once the vehicle arrives at an intended destination.

Accordingly, most types of molecular complexes that contain ligand and passenger components as disclosed herein preferably should also contain a suitable “coupling component”, which will attach the ligand and passenger components to each other by a suitable means that will balance two different needs: (i) it must be sufficiently strong and stable to enable the molecular complex to remain intact, while the ligand component is performing its role and helping pull the passenger component into a cell interior; and, (ii) in many cases, unless the passenger component can exert its desired effects while still coupled to the ligand component, the coupling means should provide some type of structure or mechanism that can allow the passenger component to eventually be released or detached from the molecular complex, after the molecular complex has successfully entered a cell.

This patent application is not an appropriate forum for an exhaustive review of candidate coupling components that can achieve and/or balance those two competing goals. A variety of such candidate coupling components are known to those skilled in the art of drug delivery, and any such candidate coupling component can be evaluated for use in a particular molecular complex as disclosed herein, after the complete details of the ligand component, the passenger component, and the targeted cell type are all known.

Some of the broad classes of coupling compounds should be briefly mentioned, to provide an overview and working introduction to the range of options that will be available when a particular type of molecular complex is being designed to optimize a combination of a known ligand, a known passenger molecule, and a known targeted cell type:

1. crosslinking agents that form covalent bonds by using relatively non-specific reactive groups, such as glutaraldehyde and other compounds that contain two aldehyde or other non-specific reactive groups at opposite ends of a spacer chain having a controlled length.

2. crosslinking agents that form covalent bonds, but only with specific molecular groups. These include “sulfo-SMCC”, described in Example 3, which is used to crosslink an end of a DNA strand to a lysine residue in a polypeptide, for purposes such as genetic vectors and affinity purification.

3. affinity binding agents, which can have very high levels of tightness and avidity (as occur between two polypeptides called biotin and avidin, mentioned in Example 6), and which can have virtually any desired lower but still substantial level of tightness and avidity (which can be controlled by various means, such as by controlling the elution conditions during an affinity purification procedure).

4. coupling agents that use ionic attraction and/or hydrogen bonding to hold two components together. Since ionic attraction and hydrogen bonding are not especially strong, these types of agents typically involve compounds that contain multiple ionic charges, all of the same polarity, packed together in a fairly close arrangement. Examples include polylysine, polyethylenimine, and other positively-charged compounds that will attract and associate with negatively-charged phosphate groups in the backbones of strands of DNA and RNA.

5. special types of connector molecules that are designed to weaken and break, when a molecular complex is subjected to acidity (such as occurs in lysosomes, which are acidic digestive organelles inside cells). These types of connector molecules are described in U.S. Pat. No. 4,631,190 (Shen et al 1986) and U.S. Pat. No. 5,144,011 (Shen et al 1992).

This is just a brief overview, and other types of connector molecules are also known to those skilled in the art. Nevertheless, it should be adequately clear that various known options with a wide range of strength, stability, and other traits are available, for coupling passenger components to ligand components.

Overview of Examples

Because of the complexity of the methods that are described in the Examples, and of the specific types of phages and cells that were used as reagents in those tests, and because some of the test procedures that were eventually settled upon were chosen after the Applicants analyzed prior efforts that did not succeed, this section is intended to offer an overview and a narrative summary of the examples, and of how their information is organized.

Examples 1 describes three types of bacteriophages that were used. These included: (1) M13KO7 helper phages, which carry no endocytotic ligands; (2) a phage display library known as the scFv library, which contains roughly 13 billion different phagemids, each of which carries a candidate ligand that normally appears in human antibodies; and (3) a phage display library known as the PhD-C7C library, which carries small foreign polypeptide sequences that contain 7 amino acid residues, which were sequenced together randomly, using “combinatorial chemistry”.

Example 2 describes the host cells (mainly the TG1 strain of E. coli cells) that were used, and it describes several techniques that were used with numerous phage populations, to amplify and titer those particular phage populations.

M13KO7 helper phages are described first, in Example 1, even though they do not carry ligand polypeptides, because they were used to create antibody-phage conjugates. These conjugates were prepared to display copies of the MC192 monoclonal antibody, which is known to be internalised by rat p75 receptors, crosslinked to the surfaces of the helper phages. These antibody-phage conjugates were tested first, and shown to be internalised by sciatic nerve fibers. Accordingly, these established a set of tools (comparable to probe drugs) that enabled the Applicants to work out the concepts and details of an effective approach that allows in vivo screening for endocytosis, in rats by manipulating sciatic nerve fibers. The methods that were used to crosslink the antibodies to the helper phages are described in Example 3, and the methods that were eventually developed to achieve endocytosis and retrograde transport of the antibody-phage conjugates, in sciatic nerves, are described in Examples 4 and 5. The methods and reagents that were used to create photographic proof of endocytosis and retrograde transport of those antibody-phage conjugates, as shown in FIG. 2 of this application, are described in Example 6.

After the antibody-phage conjugates were used to develop a set of consistent procedures for achieving reliable uptake of phage particles via p75 receptors, the Applicants began testing a phage display library known as the scFv library. The major traits of that library are described in Example 1. Very briefly, it contains a huge number (roughly 13 billion) of foreign gene inserts that were initially obtained from human B-cells. These gene inserts encode the “variable fragments” of a wide range of human antibodies, from people of different ancestries. The initial in vivo screening tests that were done with this library did not provide consistent results. Therefore, the Applicants wrestled with those problems, and eventually settled on a process of pre-screening the scFv library, in vitro, using a technique called “biopanning”, described in Example 7. Very briefly, this pre-screening involves p75 polypeptides that have been immobilized on a hard plastic surface. Phage particles that bind to these immobilized p75 polypeptides were selected by this step, and used for subsequent in vivo screening, which provided much more consistent results that could be understood and interpreted. These procedures, and the results that were obtained, are described in Example 8.

Subsequently, the Applicants also tested their in vivo screening method on a second phage display library, called the PhD-C7C library. As summarized in Example 1, this library was created by combinatorial chemistry, and contains short polypeptide segments (with 7 amino acid residues) that were randomly generated, and inserted into the pIII coat proteins of the phages. These tests, and their results, are described in Example 9.

The results of all of these screening tests confirm that in vivo screening of phage libraries, to select particular phages that are internalised and transported by neuronal fibers, is indeed a practical and effective way of identifying and isolating, from a large display library, particular phages that happen to carry ligand components that can activate and drive the process of endocytosis into nerve fibers.

These results, taken together, also confirm that stochastic processes are involved, which rely on probability, and on the sizes of the populations that are being challenged and tested in a highly specialized set of tests. The assertion and claim herein is not that this type of selection process will succeed, in each and every screening attempt or round. Instead, the assertions and claims made herein center on the fact that this selection process, which uses in vivo tests on living animals in ways that were not previously known or possible, can be used (in repeating cycles, if desired) to identify, select, and isolate a small number of clonal display phages that will successfully enter into and be retrogradely transported by neuronal fibers, from among a potentially huge and/or random starting library or repertoire.

These titering and photographic data also clearly demonstrate that this approach enables an in vivo screening method that can effectively identify ligand molecules and ligand fragments that can activate and drive the process of endocytosis, even when coupled to large molecular complexes. Based on those results, this type of in vivo screening method can enable researchers to identify such molecules (referred to herein as “endocytotic ligands”), and use them as part of a molecular transport system (which can also be called a carrier, vehicle, etc.) that can be used to transport “passenger” or “payload” components into cells. Such passenger components can include, for example, DNA segments that are part of genetic vectors, drug or diagnostic molecules that can provide therapeutic, diagnostic, or other medical benefits, and analytical compounds that would be more useful, in industrial research and similar endeavors, if they could be transported efficiently into cells.

It should also be disclosed that, as this patent application is being written and filed, none of the nucleotide gene sequences that encoded the polypeptide ligands that performed well in the in vivo screening tests are yet known, and none of the amino acid sequences of those polypeptide ligands are known. The laboratories of the Applicants herein (which are located in Australia) do not have the types of machines that are used to determine nucleotide or amino acid sequence information. Accordingly, the Applicants shipped copies of a number of selected phages that performed well in their in vivo screening tests, to an outside contract laboratory which is equipped to determine those sequence data. However, the resulting data have not yet been received, and those sequences are not yet known, as of the day this patent application is being filed.

### EXAMPLES

### Example 1

### Phage Types and Libraries

M13KO7 helper phages can be purchased from various commercial suppliers, such as New England Biolabs (www.neb.com) and Amersham Biosciences (www4.amershambiosciences.com). This strain of helper phage contains fully functional genes that encode both the pIII and pVIII coat proteins. It also contains an origin of replication (from plasmid p15a) which is tightly controlled in a manner that results in low copy numbers in bacterial cells. It also contains a mutated (Met-40-Ile) copy of the phage M13 pII gene, which is essential for phage replication; this mutation causes it to be secreted by E. coli cells, as phage particles, in low copy numbers. It also carries a kanamycin resistance gene, inserted at the Ava I site within the M13 origin of replication. This kanamycin gene functions as a selectable marker in E. coli host cells that are not resistant to kanamycin. Additional information on using and culturing these helper phages is available from commercial suppliers, and in various published articles describing their use.

The scFv phage library was supplied by Cambridge Antibody Technology (Cambridge, England; www.cambridgeantibody.com). It is described in various patents (such as U.S. Pat. No. 6,172,197) and published articles. It was created by inserting gene sequences obtained from B-lymphocyte cells (which create antibodies) into the gene sequences that encode the pIII coat protein (which is located, in relatively small numbers, at one end of filamentous M13 phage particles). Each foreign gene sequence in the scFv library contains both the “heavy variable” (V_{H}) and “light variable” (V_{L}) domains of a single antibody, in a single gene sequence that will express the V_{H} and V_{L} domains in a “single chain” (sc) polypeptide, having an average molecular weight of about 35 kilodaltons. The scFv library has an estimated 13×10⁹ (i.e., 13 billion) different recombinants. To ensure maximal diversity, it contains “variable fragment” (Fv) antibody domains obtained from numerous people of different ancestries. The library is estimated to encode a range and diversity of different Fv antibody domains that could be generated by the immune systems of ten different people from a varied assortment of racial and ethnic groups.

It should also be noted that the scFv phages are phagemids. They have a bacterial origin of replication, which causes them to reproduce in high copy numbers, as double-stranded plasmids, in E. coli cells. They also contain a phage origin of replication, which can trigger the synthesis of single-stranded DNA for assembly into phage particles; however, that ssDNA synthesis requires a phage ssDNA transcribing protein to be present, and scFv phages do not encode that protein. That ssDNA transcribing protein must be supplied by helper phages, such as the M13KO7 helper phages mentioned above.

Therefore, when M13KO7 helper phages are used to coinfect E. coli cells that have already been infected by scFv phagemids, the addition of the ssDNA transcribing protein (from the helper phages) to cells that already contain large numbers of dsDNA plasmids (from the scFv phagemids) will trigger the formation of large numbers of ssDNA strands, from the scFV phagemid plasmids. These newly formed ssDNA strands will then be packaged inside coat proteins (mainly pVIII coat proteins from a particular scFV clone which infected that host cell). The newly packaged ssDNA and its coat proteins will secreted by the host cell, as filamentous phage particles. Most of these secreted phage particles will contain scFv phagemid DNA, rather than M13KO7 helper phage DNA, since the helper phage DNA sequences will be present in the host cells only in low copy numbers (due to the low-copy-number plasmid p15a origin of replication in the helper phage DNA).

The pVIII coat proteins in the phage particles that are secreted by a some particular E. coli host cell will contain clonal copies of some particular antibody “variable fragment” polypeptide sequence, which was encoded by a DNA sequence that was obtained from a human B-lymphocyte. This human antibody DNA sequence was inserted into the scFv phagemid DNA at a controlled and targeted site, near the middle of the phagemid gene that encodes the pVIII coat protein.

The Ph.D-C7C phage display library was obtained from New England BioLabs (www.neb.com, catalog number 8120). This library contains an estimated 2×10⁹ different recombinants, with foreign DNA inserts encoding random sequences of seven amino acid, inserted near the DNA sequence that encodes the N-terminus of the pIII coat protein of M13 phages. This library provided an essentially random repertoire of peptide sequences that could be tested, to determine whether certain phages would be internalized and transported by neurons in the sciatic nerve bundle.

### Example 2

### Cell Types, Traits, and Methods

Except as otherwise noted, all phage amplification and titering used the TG1 strain of E. coli, from Cambridge Antibody Technology. This strain, which was specifically designed and developed for working with M13 phages, is also sold by companies such as Stratagene (La Jolla, Calif.; www.stratagene.com). Additional information describing culturing and transformation methods for this strain can be downloaded at no cost from the websites of commercial suppliers.

Among other features, the TG1 strain has a “lacIq” repressor gene which, together with catabolite repression by glucose, negatively regulates a “lac” promoter that has been placed in control of expression of the M13 gene that encodes the pIII phage coat protein. Most types of M13 phages that are used with TG1 cells contain an “amber” stop codon, inserted at the start of the pIII gene. As described below, this allows expression of pIII polypeptides (including chimeric pill polypeptides that contain foreign amino acid sequences) in soluble form, in a non-suppressing E. coli strain such as HB2151, without having to reclone the gene.

The “amber” stop codon can be effectively inactivated by transferring TG1 cells into culture medium that contains no glucose, and that instead contains lactose (a particular type of sugar molecule) as the sole source of carbon for the bacteria. A compound called iso-propyl-thio-galactopyranoside (IPTG) is also added; this potently induces expression of the “lac” operon, which enables the host cells to metabolize lactose molecules as a nutrient. In addition to enabling transformed cells to grow in media with lactose as a sole carbon source, it also enables transformed cells to convert a chemical called X-Gal into a bright blue color, so that transformed colonies can be easily identified and isolated, on agar plates.

In a typical procedure used to “amplify” (reproduce) a particular assortment of phages (such as after an in vitro panning or in vivo selection procedure as described herein), a colony of TG1 cells that had been grown on an agar plate was used to inoculate liquid culture media which contained 16 g tryptone, 10 g yeast extract, and 5 g NaCl per liter (this type of liquid culture media, containing tryptone and yeast extract, is referred to as 2TY media). The cells were replicated in a shaking incubator to an optical density (OD₆₀₀, measured at a light wavelength of 600 nanometers) of about 0.5 to 0.8 units (all incubations were done at 37° C., unless otherwise indicated). A phage preparation was added to the E. coli culture, and the mixture was incubated. Initial incubation was carried out in stationary conditions, for 30 minutes, to facilitate binding of the phages to the bacterial cells. This was followed by 30 minutes in a shaking incubator running at 200 rpm, to ensure maximal exposure of the cells to fresh nutrients.

These cells were then centrifuged at 3500 rpm for 10 minutes, and the supernatant containing old broth and metabolites was discarded. The cell pellet was resuspended in 500 microliters (μL) of fresh 2TY culture broth, and the mixture was spread across the surfaces of four fairly large (24.3 cm×24.3 cm) square plates containing 2TY agar media with ampicillin and glucose. The plates were incubated overnight at 30° C. Because ampicillin was present, only E. coli cells that contained scFv phagemids or PhD-C7C phages gave rise to colonies on the plates.

The following day, to complete the preparation of standardized phage solutions that could be frozen until needed, colonies were scraped from each agar plate into 10 mL of 2TY broth, in a 50 mL tube. A half-volume of sterile 100% glycerol was added, and the solution was mixed by placing the tube in an end-over-end rotator for 10 minutes at room temperature. 1 mL aliquots were frozen at −70° C. for storage.

When a batch of phages was needed for a test, a 1 mL aliquot of the glycerol-containing stock was thawed, and 100 μL of the thawed stock was added to 25 mL of 2TY broth containing 2% (w/v) filter-sterilized glucose and 100 mg/mL ampicillin. The cells were grown at 37° C. in a shaking incubator until they reached an OD₆₀₀ density of about 0.5 to 0.8. M13KO7 helper phages were then added, to form a final concentration of 5×10⁹ “colony forming units” (cfu) per mL. The mixture was incubated for 30 minutes while stationary, then for 30 minutes in a shaker tray at 200 rpm. The cells were then centrifuged at 3500 rpm for 10 minutes, and the cell pellet was resuspended in 25 mL prewarmed 2TY (without glucose) containing kanamycin (50/g/mL) and ampicillin (100 μg/mL). These were incubated overnight at 25° C., with rapid shaking, to produce phage particles.

The phage particles were purified from the supernatant by precipitation with 20% polyethylene glycol (PEG) and 2.5 M NaCl. These particles were then resuspended in a final volume of 1.5 mL of sterile phosphate buffered saline (PBS) at about 4° C.

To “titer” a solution that contains phage particles (i.e., to obtain an estimate of how many infective phage particles were present in each mL of solution), TG1 cells were grown in 2TY media, in a shaking incubator at 300 rpm for about 4 hrs, until an OD₆₀₀ density of about 0.5 to 0.8 was reached. A sample of phage supernatant was serially diluted at 10-fold dilutions, in 2TY media, by adding 50 μL of each dilution in the series to a 450 μL suspension of TG1 cells in an Eppendorf tube. The tube was incubated stationary for 30 minutes, followed by shaking at 300 rpm for 30 minutes. 100 μL of each dilution of the infected TG1 cells were streaked onto prewarmed 2TY agar plates (2TY media containing 100/g/mL ampicillin, 2% w/v filter-sterilized glucose, and 1.5% w/v agar). The plates were incubated overnight, and the following day, the number of colonies were counted. TG1 cells could grow on ampicillin-containing media only if they carried ampicillin resistance genes from a phage.

### Example 3

### Cross-Linking of P75 Receptor-Binding Antibodies MC192) to M13KO7 Helper Phages

A monoclonal antibody preparation known as MC192 (and by similar terms, such as clone 192; originally described in Chandler et al 1984) is commercially available from various suppliers, such as Cell Sciences (www.cellsciences.com) and Chemicon (www.chemicon.com). These monoclonal antibodies bind to “low affinity” (p75) nerve growth factor receptors on rat neurons. Monoclonal antibodies that bind to human p75 receptors are also available, from companies such as United States Biological (www.usbio.net).

Unlike various other monoclonal antibodies that also bind to p75 receptors in rats, the MC192 antibody can trigger endocytosis of the antibody-receptor complex, leading to neuronal uptake of the MC192 antibody. This has been shown by studies using radiolabelled antibodies (Johnson et al 1987, Yan et al 1988).

To evaluate the ability of the MC192 antibody to drive endocytosis of phages into rat neurons, a preparation was made, containing MC192 antibodies that were chemically crosslinked to M13KO7 helper phages, using a multi-step process. First, sulfosuccinimidyl-4-(N-maleimidomethyl)cyclohexane-1-carboxylate (abbreviated as sulfo-SMCC; purchased from the Pierce company, Australia) was reacted (through the active sulfo-NHS ester end) with primary amine groups on the MC192 antibody. This resulting in the formation of an amide bond between the antibody and each cross-linker group, with sulfo-NHS being released as a byproduct. To remove unreacted sulfo-SMCC, the activated antibody was purified using Microcon YM-100 centrifugal filter (100 kilodalton cut-off; catalog number 42412, Millipore Corporation, USA).

In the next phase, M13KO7 phages were incubated with 2-iminothiolane (2-IT; also called Traut's reagent) to generate free sulfhydryl groups; these groups are positioned at the ends of short chains that are bonded to lysine residues, in the pVIII coat protein of the phages. The phages were filtered, using YM-100 kDa filters, to remove excess reagent.

The antibody preparation was then mixed with the phage preparation, at a 1:10 ratio, to form thioester crosslinking bonds, from the maleimide groups on the activated antibodies and the sulfhydryl groups on the activated phages. The reaction product was filtered to remove excess antibodies, and iodoacetamide (Sigma Chemical) was added to block any remaining free reactive sulfhydryl groups. The reaction product was precipitated twice in PEG/NaCl (20% w/v polyethylene glycol, average molecular weight 8000, in water with 2.5 molar NaCl) to remove free antibodies.

The resulting phage mixture contained various numbers of MC192 antibodies, located randomly along the length of the phage. Because of the 10:1 ratio of antibodies to phages in the reaction mixture, it was presumed and estimated that on average, from about 2 to about 20 antibodies were bonded to most phage particles.

### Example 4

### Surgical Treatment and Phage Emplacement in Rats

Female Sprague-Dawley rats were used, and surgeries were performed under halothane anaesthetic (2% in oxygen, administered by nose cone connected by tubing to anesthetic machine). Alternatively, longer-acting injectable anesthetics such as sodium pentobarbitone may be used if desired.

Certain comments are offered below, about preferred procedures for doing this type of surgery on rats, since the use of correct procedures will substantially increase the likelihood of success. Many people who are quite familiar with cells and phages may not be familiar with small animal surgery, as is necessary to carry out the in vivo procedures of this invention.

It should also be noted that whenever someone is doing this type of surgery for the first time, a binocular microscope that can provide up to 20× magnification is almost always used, during training, to help focus the vision and attention on important sites and aspects of the procedure. After conducting a procedure a few times, a technician can choose whether or not to use a microscope during subsequent procedures (or during a delicate or difficult part of a procedure, such as suturing the two ends of a sciatic nerve together, after placing the phage-containing gel foam between the nerve ends). If mice are used, their smaller size might dictate use of a binocular microscope for all procedures, until a technician develops a fairly high level of experience and familiarity with the procedures.

When the rats were 6 weeks of age, an initial surgery was performed, to “upregulate” (increase) expression of the p75 cell receptors. If the sciatic nerve is injured in this manner, the motor neurons (which have their cell bodies in the spinal cord, and axonal fibers projecting through the sciatic nerve) are stimulated to express increased numbers of p75 receptors on their cell and axonal surfaces. Tests that were conducted to compare the differences between phage uptake by pre-ligated neurons, versus phage uptake by non-ligated neurons, indicated that the pre-ligation step increased p75 receptor density and phage uptake by roughly 13-fold. These tests included phage uptake tests, as well as staining (using MC192 antibodies) of tissue sections taken from the lumbar regions of spinal cords of rats.

Two other factors should also be noted about p75 receptors, in rats. First, it is present in substantial numbers on the surfaces of motor neurons that originate in the spinal cord, and that send out axons or other neuronal fibers into muscle tissues that are not enclosed within the blood-brain barrier. This includes sciatic nerves; however, the p75 receptor is present in substantial copy numbers, on sciatic nerve surfaces, for only about two weeks after a rat is born, while the rat is growing rapidly. After about one to two weeks, its copy number on sciatic nerves drops off, and by the time rats are about 6 weeks old, it is present on sciatic nerve surfaces only in very low and often undetectable quantities.

The second notable factor is this: since p75 receptors are not abundant on sciatic nerve surfaces in rats that are 3 weeks old or older, even after a controlled injury has been inflicted on a sciatic nerve, the p75 receptor endocytosis system can be saturated, fairly easily. It apparently was saturated, on a number of occasions, during the in vivo screening tests described herein. However, rather than invalidating any of the results disclosed herein, this factor should be regarded more as a “ceiling” value, which cannot be exceeded. Accordingly, these saturation limits can be approached and utilized in ways that appear to confirm and validate the mechanisms and effects that are believed by the Applicants to be active in these types of in vivo screening tests using p75 receptors.

During the initial surgery, there is no need to use any mechanical restraint. The animal is laid on its side with the hindlimb uppermost, fur shaved and skin swabbed. A 1 to 3 cm midthigh skin incision in parallel with the femur is made, using surgical scissors or scalpel. Using the tip of closed surgical scissors (blades 2 to 4 cm long), the femur is located by palpation, and the point of the scissors is pushed, just caudal to the femur, through the muscle layers to a depth of 1 to 2 cm, depending on the size of the animal. The scissors are then opened, to separate the muscle with minimal bleeding, and to create a 1 to 2 cm window which exposes the sciatic nerve lying beneath the muscle. Retractors or sutures can be used to hold open the muscle and maximize the window of operation, but this may not be required by an experienced technician.

By using this entry procedure, the sciatic nerve can be clearly seen. The sciatic nerve is only loosely attached to the surrounding tissues, by membranes that are easily separated. The nerve itself is protected by a tough nerve sheath, and an estimated 50,000 axons may be contained within this nerve bundle, depending on the location. While the axons of some sympathetic or other nerve may not be myelinated, each motor axon (and most sensory nerve axons) is surrounded by a myelin sheath, contributed by Schwann cells, which make up the bulk of nerve tissue mass outside the blood brain barrier.

A ligature is emplaced by inserting a pair of curved forceps under the sciatic nerve, and used the forceps to gently lift the nerve and free any loosely adhering membranes, if present, from a 1 to 2 cm length. The forceps are opened and used to grasp a length of 6/0 silk suture, which is then pulled under the nerve by withdrawing the forceps. The suture, which is placed at a site slightly above the location where the tibial branch bifurcation divides the sciatic nerve bundle into two smaller bundles, is then tied tightly around nerve to ligate it. It is important to use non-resorbable sutures, such as silk or nylon. Black silk is generally preferred, since it is less elastic (making tight ligations easier to secure), and because a black ligature is more easily located during a subsequent operation.

The instruments are withdrawn, the separated muscles are allowed to rejoin, and the skin incision is closed with 1, 2 or 3 sutures, depending on the length of the incision. The animal is then allowed to recover from anesthesia.

Seven days later, the sciatic nerve was exposed again, and a 2 to 3 mm section of the sciatic nerve which contained the ligature was excised, using a pair of surgical scissors.

Roughly 9 cubic millimeters of a collagen matrix gel foam, containing 10 μl of the MC192-M13KO7 antibody-phage conjugate (with titers ranging from about 3.3×10⁶ to about 2.1×10⁹ cfu/mL) was inserted between the two transected ends of the nerve bundle.

The free ends of the sciatic nerve were sutured together, flanking the gel foam that contained the phages, using a 10-0 nylon surgical suture. A small flexible sleeve of silicone rubber was placed around the nerve ends and the gel foam containing the antibody-phage conjugates, to ensure that the antibody-phage conjugates in the gel foam would remain in direct contact with the ends of the nerve fibers.

During the same surgery when the transection and phage emplacement were made, the sciatic nerve bundle was ligated, using a 6-0 silk suture, at a location about 2 cm above the transection site, near the rat's hip. This ligature is referred to herein as the hip ligature, to distinguish it from the initial ligature that was used to increase p75 receptor expression.

The hip ligature created a constriction point that prevented antibody-phage conjugates that had been taken into sciatic neurons from being retrogradely transported all the way to the spinal cords of the neurons. Therefore, antibody-phage conjugates accumulated, inside the nerve fibers, at a location that was just below (distal to) the hip ligature.

After a delay of 18 hours, to allow enough time for endocytotic uptake and retrograde transport, the rat was sacrificed by chloroform inhalation, and a nerve segment distal to the hip ligature was harvested, as disclosed in the next example.

### Example 5

### Nerve Harvesting and Internalised Phage Collection

As mentioned in the prior example, a rat was sacrificed 18 hours after: (i) emplacement of the collagen gel containing the phage particles, and (ii) emplacement of the hip ligature.

A nerve segment which included the hip ligature and a segment of nerve fibers just distal to that ligature was harvested. This was done by emplacing and tightening an additional ligature around the sciatic nerve, about 0.5 cm below (distal to) the hip ligature, to prevent any loss of the phage particles from either of the cut ends of the nerve bundle. A segment of the sciatic nerve bundle, which contained both of the two ligature loops still tied tightly around both ends of the segment, was then cut out and removed.

The excised nerve bundle was scrubbed 3 times with sterile PBS, using forceps with sterilized tissue paper, until the outer membrane was removed. The neurons were then transferred onto a dry glass plate, and the ligatures were removed.

450 μL of a lysis buffer (which digested cell membranes but not bacteriophage particles) was then applied, containing 1% Triton X-100, 10 mM Tris, and 2 mM EDTA at pH 8, and also including 1/100 (by volume) of a protease inhibitor mixture (containing 4-(2-amino-ethyl)-benzenesulfonyl fluoride, pepstatin A, E64, bestatin, leupeptin, and aprotinin in dimethylsulfoxide, purchased from Sigma Chemical, Australia). While in the lysis buffer, the nerve fibers were cut into small pieces, using a scalpel, and the resulting suspension was transferred to an Eppendorf tube and incubated at room temperature on vortex for 1 hour. The tube was then centrifuged at 10,000 rpm at 4° C. for 10 minutes, to pellet the sciatic nerve debris.

The supernatant (which contained phage particles) was collected and stored on ice, while the debris pellet was incubated with 300 μL more lysis buffer and vortexed for 1 more hour at room temperature. The lysed debris was then incubated at room temperature for 1 hour, and the sample was transferred into another Eppendorf tube and centrifuged at 10,000 rpm at 4° C. for 10 minutes, to pellet any remaining debris. The supernatant was collected and added to the previous supernatant, and a 20% volume of CaCl₂ was added, to inactivate the EDTA in the lysis buffer.

Some of the resulting aliquots of the mixed supernatants were titered, as described in Example 4, to determine phage particle concentrations. Other aliquots had a 50% volume of glycerol added, and the mixture was frozen and stored at −20° C. for subsequent use or analysis. During all but the final rounds of in vivo selection, still other aliquots were used to infect E. coli cells, and the amplified phage preparations that resulted were used as reagents in subsequent cycles of in vivo selection, using the same procedures described above.

### Example 6

### Histologic Photographs of Nerve Segments

A fluorescent staining technique was used to generate photomicrographs that visually confirmed the accumulation of internalised and transported MC192-M13KO7 antibody-phage conjugates in the sciatic nerve bundle, just below the hip ligature.

To create these photographic confirmations, the animal was euthanised with an overdose of anesthetic (sodium pentobarbitone, 80 mg/kg, injected into the abdomen IP). It was then perfusion-fixed through the heart, using 400 mL of ice cold 0.1 molar sodium phosphate buffer containing 2% paraformaldehyde and 0.2% parabenzoquinone over 30 minutes. The sciatic nerve segment containing the hip ligature was then dissected out and placed in the same fixative for an additional hour, before being transferred to 30% sucrose in sodium phosphate buffer.

The still-intact nerve bundle was then embedded in OCT compound (Tissue-Tek, Sakura Finetechnical Company Ltd., Tokyo, Japan), and frozen. Longitudinal cryostat sections (50 microns thick) were cut from the embedded and frozen nerve bundles, using a microtome.

Selected longitudinal tissue sections that had been cut from near the center of the nerve bundle were then treated with immunoreagents, to reveal the presence and concentration of phage particles. One reagent was a rabbit-derived antibody preparation (Sigma Chemicals, catalog number B2661) that binds to the pIII capsid protein on bacteriophage particles, and that also contains a Biotin polypeptide sequence. These antibodies were incubated with the tissue slice for 1 hour at room temperature. Alexa Fluor 488 (Molecular Probes, catalog number S-11223), which contains a streptavidin sequence that binds very tightly to the Biotin sequence on the phage-binding rabbit antibody, was then added and incubated for 1 hour at room temperature.

Fluorescent photographs were taken of the nerve bundle, covering a portion of the nerve bundle which included segments of nerve fibers on both sides of the hip ligature. One of those photographs, reproduced in black and white, is provided as FIG. 2 in the drawings.

That photograph (and others which showed very similar results) clearly shows that antibody-phage conjugates did indeed accumulate on the distal side of the hip ligature. These and similar photographs from other tests provide clear confirmation that the binding, endocytosis, and transport mechanisms described herein are indeed working efficiently, and in the manner disclosed.

Similar photographs and other analytical tests of a control treatment, which involved injecting M13KO7 phages without any receptor-specific internalizing antibodies crosslinked to them, showed no control phages at the same location, on the distal side of the ligatures.

The foregoing tests and results, using monoclonal antibodies affixed to phage particles, confirmed several key aspects of the invention disclosed herein. Among other things, these results confirmed that: (i) complete filamentous phage particles that could bind to p75 receptors in rat neurons could be internalized and then retrogradely transported, by sciatic nerve fibers; and, (ii) the ligation, emplacement, and harvesting protocols described above can be used satisfactorily and effectively, to accomplish in vivo screening and selection of particular ligands that can enable complete, viable, and infective phage particles to be internalised into, and then transported within, neuronal fibers, based on phage-fiber contacts that occur outside the blood-brain barrier.

Based on that confirmation of their general approach to in vivo screening using nerve fibers, and after conceiving, developing, optimizing, and confirming a combination of methods and reagents that enabled these types of in vivo screening tests to be carried out successfully and effectively, the Applicants then extended their approach, by testing it in actual in vivo screenings of phage display libraries containing huge numbers of candidate ligands.

### Example 7

### In Vitro Biopanning of scFv Phage Library

As mentioned above, the p75 receptor in rat neurons is known to have endocytotic activity. It is also known to have its copy numbers, on neuronal surfaces, increased by a factor of roughly 10 to 15 fold, in response to various types of neuronal injuries. In rats, this type of injury can be created, in a controlled and reproducible manner, by emplacement of a tight ligature loop around the sciatic nerve bundle, in a location slightly above the site of the tibial branch bifurcation, where the sciatic nerve divides into two major branches. A ligature at that site will provoke a substantial increase in p75 receptor numbers along the length of the sciatic nerve fibers between the spinal cord and the ligature site, and the affected nerve fibers segments with increased p75 receptor numbers will be long enough to enable emplacement of a phage-containing gel at one location, followed by harvesting of internalized and transported phages at a separate location.

All of these factors made the p75 receptor a useful and controllable target for initial testing and confirmation of the in vivo selection process disclosed herein, using phage display libraries with huge numbers of candidate ligands.

Accordingly, the Applicants chose to limit their first tests of the scFv phage display library to candidate ligands that could bind specifically to the p75 receptor in particular. Although the Applicants realized that other ligands in the display library (which, as mentioned in Example 1, contains an estimated 13 billion different variable fragment antibody sequences, designed to emulate the immune systems of ten different humans from widely varying ancestries) would inevitably be able to bind to other neuronal surface receptors that could trigger endocytosis and retrograde transport, their decision and goal, in their tests using the scFv library, was to limit their tests to ligands that would bind to the p75 receptor.

After an initial set of efforts, which confirmed the general principles but which also led to wide variations in the resulting data (those tests and results are described in Example 9, and arose when the Applicants began trying to evaluate cyclic repetition of the in vivo screening process, using phages selected in one cycle of tests as the starting population for the next cycle), the Applicants decided to focus on p75 receptor endocytosis by processing the scFv phage display library using an in vitro procedure called “biopanning”.

This in vitro method used a preparation of recombinant human p75 receptor polypeptides. These polypeptides, which are commercially available, encode amino acid residues 1-250 of the extracellular domain of human nerve growth factor (NGF) receptors, fused to a carboxy terminal 6× histidine-tagged Fc region of human IgG1 protein, via a peptide linker. In order to obtain glycosylated proteins, the chimeric protein is expressed in eukaryotic rather than bacterial cells, using an insect cell line known as Sf21 (from the “fall armyworm” moth, Spodoptera frugiperda), and a baculovirus expression vector. The recombinant mature chimeric protein exists as a disulfide-linked homodimer. Each monomer contains 466 amino acids and has a calculated mass of 51 kDa; however, because glycosylation increases the size and weight of the protein, each monomer migrates as a 90-100 kDa protein, when processed by electrophoresis in sodium dodecyl sulfate-polyacrylamide (SDS-PAGE) gels.

These polypeptides were coated onto the surfaces of immunotubes. This was done by using 7 mL MAXISORP™ tubes, with a polystyrene hydrophilic surface (catalog #444474, from Nalge Nunc International, Denmark). A concentration of 5 μg/mL of the recombinant human p75 receptor protein, suspended in 0.5 ml phosphate-buffered saline (PBs), was incubated overnight in the immunotubes at 4° C.

The next day, the tubes were poured out, and then rinsed with PBS, filled to the brim with 3% w/v skim milk in PBS, and blocked for 2 hours at room temperature (RT). Meanwhile, 50 μl of the scFv phage display library was pre-blocked with 450 μl of 3% skim milk in PBS in an Eppendorf tube for 1 hour at RT. The immunotubes were rinsed with PBS, then 500 μl of pre-blocked phage solution was added to the tubes, and incubated for 2 hours at RT.

After 15 washes with PBS containing 0.1% Tween 20, the remaining bound phages were eluted with 15 minute incubation of 500 μL fresh triethylamine (TEA) in a 100 mM, pH 11 solution at RT. The eluted phage were transferred into an Eppendorf tube, and neutralized by adding 250 μL of 1M Tris-HCl buffer, pH 7.4.

Half of the elutant was used to infect TG1 E. coli host cells, which were cultured to an OD₆₀₀ optical density of 0.5-0.8. The other half of the elutant was stored as a backup. The biopanned phage preparation was incubated with TG1 cells for 1 hour at 37° C., with 30 minutes under stationary, then 30 minutes of 300 rpm shaking. The infected cell solutions were then serially diluted and plated on 2TY agar plates with ampicillin, to determine phage titer.

Remaining cells were plated on four 243 mm×243 mm 2TY agar plates with ampicillin, for amplification. These plates were incubated at 30° C. overnight. Colonies were scraped into liquid 2TY broth, and grown to OD₆₀₀ levels of 0.5-0.8. M13KO7 helper phages were then added, to form a final concentration of 5×10⁹ “colony forming units” (cfu) per mL. The mixture was incubated for 30 minutes while stationary, then for 30 minutes in a shaker tray at 200 rpm. The cells were then centrifuged at 3500 rpm for 10 minutes, and the cell pellet was resuspended in 25 mL prewarmed 2TY (without glucose) containing kanamycin (50/g/mL) and ampicillin (100/g/mL). These were incubated overnight at 25° C., with rapid shaking, to produce phage particles. The phage particles were precipitated, using 20% polyethylene glycol (PEG) and 2.5 M NaCl. These particles were then mixed with a collagen gel, and a bolus of gel containing roughly 50 billion (5×10¹⁰) cfu of phages was emplaced in a rat leg during an in vivo screening operation.

Only a single round of in vitro biopanning was used prior to in vivo screening, because the Applicants wanted to preserve maximal diversity of the p75-binding ligands that would be tested in vivo. This diversity would have been jeopardized by successive in vitro screenings, because it is known that many types of p75-binding antibodies are not internalized by cells having p75 receptors. The concern is that tightly-binding ligands appear to somehow lock up and/or contort in vivo p75 receptors, in ways that impede the ability of the p75 receptors to carry out the normal process of endocytosis. Since additional rounds of in vitro biopanning would tend to select for tight-binding ligands without regard to their ability to trigger endocytosis, it could lead to elimination of candidate ligands that might be substantially more effective in achieving actual endocytotic transport into cell interiors, in vivo.

Nevertheless, three successive rounds of biopanning were carried out, using the scFv phage library, to evaluate how this library would respond to repeated rounds of in vitro screening. To establish comparable results, each solution of phages used in the second and third rounds was diluted, by PBS, to match the titer of the solution that had been used in the first round.

While the first round of biopanning resulted in scFv titers of roughly 3000 cfu (compared to control values of roughly 1200 cfu, when PBS was tested), the second round of biopanning resulted in major increases, to about 84 million cfu. A third round of biopanning resulted in titers of about 85 million cfu, which was not a significant increase over the second round.

### Example 8

### In Vivo (Sciatic Nerve) Selection of Internalised Phages from the scFv Library

As mentioned in the previous example, the “enriched” portion of the scFv phage display library that was selected by one round of biopanning (using human p75 receptor polypeptides), as described in Example 8, was used as the starting reagent in a series of in vivo screenings in rats. These in vivo screenings used the procedures and methods that had been developed, tested, and optimized by using MC192/M12KO7 antibody-phage conjugates as described in Examples 4 and 5.

Briefly, in a first operation, an initial ligature was placed just above the tibial branching of the sciatic nerve, to induce increased p75 receptor expression on the sciatic nerve fibers above the ligature. A week later, in a second operation, the sciatic nerve bundle was cut, and the cut end was packed inside a silicone rubber sleeve with collagen gel containing about 50 billion cfu of scFv phages that had been obtained by a single round of p75 biopanning. During the second operation, a ligature was also emplaced and tightened around the sciatic nerve in the hip region, to create an obstacle that would cause internalised and retrogradely transported phage particles to accumulate, inside the nerve fibers, just distal to the ligature. Eighteen hours later, in a third operation, the rat was sacrificed and a segment of nerve fibers was harvested, including the hip ligature and roughly half a centimeter of nerve fibers distal to the ligature. The harvested nerve fibers were washed, cut into small pieces, and treated to remove and isolate phage particles. The phage particles were amplified, and titers were determined, using E. coli cells and helper phages.

While the absolute number of phage recovered from an excised nerve segment varied between experiments, a standardized measure of uptake and transport was generated, by always testing a control phage population, and comparing the results to the data from the test phage population.

To illustrate, using absolute numbers that resulted from a representative experiment (n=3 for both control and test selections), 5×10¹⁰ (i.e., 50 billion) cfu (titered estimate) of control phages (unmodified M13KO7 helper phages) were emplaced into the phage contact site. The number of control phages that were recovered from the nerve segment excised 18 hours later was titered, giving a value of 14,650 (±2,975, standard error of the mean (SEM), n=3). The same quantity (5×10¹⁰ cfu) of scFv-phage (biopanned once to recognize p75, as described in Example 7) was emplaced in a phage contact site, and the number of scFv phages recovered from the nerve segment excised 18 hours later was titered at 190400 (±14,415 SEM, n=3). By comparing those two results, it was calculated that 13-fold more scFv phage (biopanned once for p75) were recovered from the excised nerve segments, than control phage. This experiment was repeated 3 times, with similar results each time.

To test whether this marked increase in uptake and transport of scFv phage was indeed the result of the scFv binding to p75, the experiment was repeated in other sets of animals, in which the sciatic nerve had not been pre-ligated (and, therefore, the motor neurons had not upregulated their expression of p75 above the very low and frequently undetectable levels that appear in rats that are more than about 2 weeks old). In these tests, the amounts of control phage (M13KO7) and test phage (scFv) that were applied were held the same as before, at 5×10¹⁰ cfu. The number of control phage that were recovered from nerve segments excised 18 hours later was 14,815±4,481 (n=3). The amount of scFv phage (biopanned once for p75 recognition) that were recovered from nerve segments excised 18 hours later was 16,413±4,541 (n=3). These data clearly showed that the efficiency of cellular intake and transport of scFv phage (biopanned once for p75 recognition) was essentially no different from that of control phage, when rats were tested that had very low levels of p75 receptors, as occurs naturally in rats that are six weeks of age or older. This confirmed that there was a clear relationship between p75 expression levels, and efficiency of uptake and transport of scFv phage that had been biopanned to recognize p75 receptors. This experiment was repeated 3 times, with similar results.

### Example 9

### Cyclic Testing of Unpanned scFv Library

In a series of tests that were performed before the in vitro biopanning procedure (described in Example 7) was settled upon and used, the scFv library was tested in a series of cyclic in vivo screening tests, using sciatic nerve fibers as described in Examples 4 and 5. These tests are referred to as “cyclic”, because a screened and selected phage population that was obtained from one round of tests was then used as a starting reagent, in the next cycle of tests.

Although these tests provided clear evidence that the phage libraries contained particular phage-borne ligands that activated and drove endocytotic internalisation and retrograde transport, the results of these cyclic tests were highly variable. The data scattering led the Applicants to conclude that the data were consistent with the following interpretations:

(i) the ligand-receptor binding and uptake process was saturable, due to the limited number of p75 receptors on the surfaces of the nerve fibers;

(ii) the input phage populations were highly diverse, with only one or a few copies of any one particular phage present in any initial round(s), and with subsequent rounds likely to contain hundreds or even thousands of different phage candidates;

(iii) therefore, the probability was quite low that any one particular phage would be selected in two different experiments on different animals (this probability can be regarded as being roughly equal to the number of copies of any one particular phage in a test population, divided by the number of alternative phages that the nerve bundle could effectively sample from).

These factors clearly can account for the very high variability seen between different experiments using different animals. Therefore, after encountering and pondering those high levels of variability, the Applicants decided to experiment with a pre-screening step (i.e., in vitro biopanning) that would reduce the variation within the input population, and that would also substantially increase the number of multiple copies of p75-binding phage candidates that would be available for the nerve bundle to sample from.

The data obtained from the scFv library tests that were done prior to the pre-screening step did indicate that the first, the second, and possibly the third successive screening cycles all appeared to lead to greater efficiencies, in internalisation and retrograde transport by the cells. However, under the particular conditions that were used, those efficiencies tended to drop off if still more cycles of in vivo screening were used. While the cause for the eventual fall-off was not clear, a significant proportion of individual colonies of phage selected from the second or third round selections can reasonably be anticipated to display ligands that bind to neuronal receptors and stimulate internalisation and retrograde transport (since they were repeatedly selected, the probability that they might be false positives is low).

Cyclic in vivo screening has not yet been evaluated thoroughly, and in particular, it has not yet been tested with a phage population that has been pre-screened, by biopanning or similar efforts. Nevertheless, the work done to date is believed to clearly demonstrate and confirm that:

(1) with at least some types of phage populations, a series of cyclic in vivo screenings, where a candidate population that has been selected by one round of screening is used as a starting reagent in the next round of screening, is indeed possible, and in at least some cases is likely to help identify and isolate candidate ligands that are exceptionally effective in triggering and driving endocytotic transport into cells; and,

(2) it is feasible to develop numerical indices that will provide useful indicators of when a cyclic process should be stopped, to allow careful analysis and sequencing of candidate ligands that appear to offer the best performers that have been identified up until that point in the screening process.

(3) it is also likely that at least some of the phage ligands stimulated internalisation and retrograde transport after binding to surface molecules that were not previously known to mediate endocytotic events.

Finally, in considering the implications of these analyses, it should be borne in mind that the fundamental and overriding goal of this type of in vivo screening is not to create a highly enriched or “elite” phage population, that can offer many thousands of phage candidates that will be internalised by nerve fibers. Instead, the goal is to identify and isolate (and, in the case of polypeptide ligands, to determine the nucleotide gene sequence and/or the amino acid polypeptide sequence of) just one or a small number of particular ligands that are highly effective in activating and drive the process of endocytotic internalisation. These are the types of ligands that, once they have been identified and isolated, can be replicated in mass, and incorporated into molecular complexes that will transport useful passenger or payload molecules into specific classes of cells that have specific targeted endocytotic receptors or similar molecules on their surfaces.

It must also be kept in mind that a biopanning step, as described above for using p75 polypeptide sequences to pre-screen the scFv phage library, can be carried out by using (as the “antigen” molecule that will be affixed to the surfaces of the immunotubes) any known polypeptide sequence or fragment, from any type of known or suspected endocytotic receptor, or from other surface molecule suspected of having endocytotic activity. It can also be carried out by using any glycosylated cell surface molecules that are suspected of having endocytotic activity.

### Example 10

### In Vivo Selection, using PhD-C7C Phage Library

As briefly mentioned in Example 1, the Ph.D-C7C phage display library contains an estimated two billion different phages, with foreign DNA inserts that encoding random sequences of seven amino acids, inserted near the DNA sequence that encodes the N-terminus of the pIII capsid protein of M13 phages. This library provided an essentially random repertoire of peptide sequences that could be tested, to determine whether certain phages would be internalized and transported by neurons in the sciatic nerve bundle.

In vivo screening of the PhD-C7C library, using the sciatic nerve procedures disclosed above, indicated that this library performed just as expected. Substantial numbers of phages were internalized by the sciatic nerve fibers, and transported to a phage accumulation zone immediately distal to the hip ligature. Selected phages were removed, in viable form, from the harvested nerve segments, and those p75-selected viable phages could be replicated and manipulated in any way of the ways described above.

If desired, as indicated above, the PhD-C7C library also can be pre-screened, using a biopanning technique (as described above for the p75 biopanning of the scFv library), using any known and available type of receptor polypeptide sequence as the biopanning antigen.

Thus, there has been shown and described a new and useful method for (i) using in vivo screening, to identify ligands that can efficiently activate and drive the process of cellular endocytosis, via selected endocytotic molecules that are present on the surfaces of only limited numbers and types of cells, and (ii) incorporating those ligands into molecular complexes that can be used to efficiently transport useful passenger or payload molecules into cells having the targeted endocytotic receptors or other surface molecules. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

### REFERENCES

Barry, M. A., et al, “Toward cell-targeting gene therapy vectors: selection of cell-binding peptides from random peptide-presenting phage libraries,” Nature Medicine 2: 299-305 (1996).
Becerril, B., et al, “Toward selection of internalizing antibodies from phage libraries,” Biochemical & Biophysical Research Communications 255: 386-93 (1999).
Chandler, C. E., et al, “A monoclonal antibody modulates the interaction of nerve growth factor with PC12 cells,” Journal of Biological Chemistry 259: 6882-9 (1984)
Edwards, P. J., “Purification strategies for combinatorial and parallel chemistry,” Comb Chem High Throughput Screen 6: 11-27 (2003)
Edwards, P. J., et al, “Solid-phase compound library synthesis in drug design and development,” Curr Opin Drug Discov Devel 5: 594-605 (2002)
Ernfors, P., et al, “Expression of nerve growth factor receptor mRNA is developmentally regulated and increased after axotomy in rat spinal cord motoneurons,” Neuron 2: 1605-13 (1989).
Ferguson, I. A., et al, “Comparison of wheat germ agglutinin-horseradish peroxidase and biotinylated dextran for anterograde tracing of corticospinal tract following spinal cord injury,” Journal of Neuroscience Methods 109: 81-9 (2001)
Flynn, D. L., et al, “Recent advances in chemical library synthesis methodology,” Curr Opin Drug Discov Devel 5: 580-93 (2002)
Geysen, H. M. et al, “Combinatorial compound libraries for drug discovery: an ongoing challenge,” Nat Rev Drug Discov 2: 222-30 (2003)
Hart, S. L., et al, “Cell binding and internalization by filamentous phage displaying a cyclic Arg-Gly-Asp-containing peptide,” Journal of Biological Chemistry 269: 12468-74 (1994)
Johnson, D., et al, “Expression and structure of the human NGF receptor,” Cell 47: 545-54 (1986)
Johnson, E. M., Jr. et al, “Demonstration of the retrograde transport of nerve growth factor receptor in the peripheral and central nervous system,” Journal of Neuroscience 7: 923-9 (1987)
Griffin, J. W., et al, “The pathogenesis of reactive axonal swellings: role of axonal transport,” Journal of Neuropathology & Experimental Neurology 36: 214-27 (1977)
Griffiths, A. D. & Duncan, A. R., “Strategies for selection of antibodies by phage display,” Current Opinion in Biotechnology 9: 102-8 (1998)
Ivanenkov, V., et al, “Uptake and intracellular fate of phage display vectors in mammalian cells,” Biochimica et Biophysica Acta 1448: 450-62 (1999)
Ivanenkov, V. V. & Menon, A. G., “Peptide-mediated transcytosis of phage display vectors in MDCK cells,” Biochemical & Biophysical Research Communications 276: 251-7 (2000)
Johnson, E. M., et al, “Expression and possible function of nerve growth factor receptors on Schwann cells,” Trends in Neurosciences 11: 299-304 (1988)
Larocca, D., et al, “Targeting bacteriophage to mammalian cell surface receptors for gene delivery,” Human Gene Therapy 9: 2393-9 (1998)
Larocca, D., et al, “Receptor-targeted gene delivery using multivalent phagemid particles,” Molecular Therapy: the Journal of the American Society of Gene Therapy 3: 476-84 (2001)
Lepre, C. A., “Applications of SHAPES screening in drug discovery,” Comb Chem High Throughput Screen 5: 583-90 (2002)
Ley, S. V., et al, “New tools and concepts for modern organic synthesis,” Nat Rev Drug Discov 1: 573-86 (2002)
Liu, R., et al, “Combinatorial peptide library methods for immunobiology research,” Exp Hematol 31: 11-30 (2003)
Lockhoff, O., et al, “Glycoconjugate libraries accessed by multicomponent reactions,” Comb Chem High Throughput Screen 5: 361-72 (2002)
Poul, M. A., et al, “Selection of tumor-specific internalizing human antibodies from phage libraries,” Journal of Molecular Biology 301: 1149-61 (2000)
Poul, M. A. & Marks, J. D., “Targeted gene delivery to mammalian cells by filamentous bacteriophage,” Journal of Molecular Biology 288, 203-11 (1999)
Ramstrom, O., et al, “Chemical biology of dynamic combinatorial libraries,” Biochim Biophys Acta 1572: 178-86 (2002)
Yan, Q., et al, “Retrograde transport of nerve growth factor (NGF) in motoneurons of developing rats: assessment of potential neurotrophic effects,” Neuron 1:335-43 (1988)

1. A molecular complex, comprising:
a. at least one ligand component that was identified by a process of in vivo selection that required endocytotic uptake into neuronal fibers for such selection to occur, and,
b. at least one passenger component capable of causing a desired effect after such passenger component has been transported into a targeted mammalian cell having endocytotic surface molecules to which the ligand component will specifically bind,
wherein the molecular complex enables ligand-mediated endocytotic transport of the passenger component into at least one class of targeted mammalian cells having endocytotic surface molecules to which the ligand component will specifically bind.

2. The molecular complex of claim 1, which also comprises at least one coupling component that couples the passenger component to the ligand component in a manner that enables the passenger component to enter at least one class of targeted mammalian cells when the molecular complex undergoes ligand-mediated endocytotic transport into such cells.

3. The molecular complex of claim 1, wherein the process of in vivo selection of the ligand component also required intracellular transport within neuronal fibers, following endocytotic uptake of the ligand component into the neuronal fibers.

4. The molecular complex of claim 1, wherein the process of in vivo selection comprised the following steps:
(1) emplacing a multiplicity of candidate ligand components into an emplacement site in a living mammal, in a manner that caused contact between said candidate ligand components, and surfaces of neuronal fibers;
(2) harvesting, at a harvesting site located away from the emplacement site, isolated segments of neuronal fibers that contained ligand components that had been successfully internalised and transported by the neuronal fibers; and,
(3) removing, from said isolated segments of neuronal fibers, ligand components that had been internalised and transported by the neuronal fibers.

5. The molecular complex of claim 4, wherein the candidate ligand components were exposed on phage particle surfaces in a phage display library, during the in vivo selection process.

6. The molecular complex of claim 4, wherein the candidate ligand components were generated by a process of combinatorial chemical synthesis.

7. The molecular complex of claim 4, wherein the candidate ligand components were processed by an affinity binding step prior to the in vivo selection process.

8. The molecular complex of claim 1, wherein the ligand component specifically binds to low-affinity nerve growth receptors.

9. A molecular complex suited for therapy or analysis of mammalian cells, comprising:
a. at least one endocytotic ligand component that was selected by a process of in vivo selection that required endocytotic uptake through a targeted class of endocytotic surface molecules for such in vivo selection to occur; and,
b. at least one passenger component that will cause a desirable effect after such passenger component has been transported into a mammalian cell having the targeted class of endocytotic surface molecules,
wherein the molecular complex is designed to undergo ligand-mediated endocytotic transport into at least one class of mammalian cells having the targeted class of endocytotic surface molecules.

10. The molecular complex of claim 9, which also comprises at least one coupling component that couples the passenger component to the ligand component in a manner that enables the passenger component to enter at least one class of targeted mammalian cells when the molecular complex undergoes ligand-mediated endocytotic transport into such cells.

11. The molecular complex of claim 9, wherein the process of in vivo selection of the ligand component required endocytotic entry of the ligand component into neuronal fibers.

12. The molecular complex of claim 9, wherein the process of in vivo selection comprised the following steps:
(1) emplacement of a multiplicity of candidate ligand components into an emplacement site in a living mammal, in a manner that caused contact between said candidate ligand components, and surfaces of neuronal fibers;
(2) harvesting, at a harvesting site located away from the emplacement site, isolated segments of neuronal fibers that contained ligand components that had been successfully internalised and transported by the neuronal fibers; and,
(3) removing, from said isolated segments of neuronal fibers, ligand components that had been internalised and transported by the neuronal fibers.

13. The molecular complex of claim 12, wherein the candidate ligand components were exposed on phage particle surfaces in a phage display library, during the in vivo selection process.

14. The molecular complex of claim 12, wherein the candidate ligand components were generated by a process of combinatorial chemical synthesis.

15. The molecular complex of claim 12, wherein the candidate ligand components were processed by an affinity binding step prior to the in vivo selection process.

16. The molecular complex of claim 12, wherein the ligand component specifically binds to low-affinity nerve growth receptors.

17. A purified preparation of endocytotic ligands, comprising a multiplicity of endocytotic ligands having a molecular structure that was identified by a process of in vivo selection that required endocytotic uptake into neuronal fibers for such selection to occur, and wherein said ligands are suited for being coupled to passenger components in a manner that will form molecular complexes that can exert a desired effect after said molecular complexes have entered at least one class of targeted mammalian cells having endocytotic surface molecules to which the endocytotic ligands will specifically bind.

18. The purified preparation of claim 17, wherein the endocytotic ligands are substantially free of additional ligand candidates that cannot bind to endocytotic surface molecules to which the endocytotic ligands will specifically bind.

19. The purified preparation of claim 17, wherein the process of in vivo selection also required intracellular transport within neuronal fibers, following endocytotic uptake of candidate ligand components into the neuronal fibers.

20. The purified preparation of claim 17, wherein the process of in vivo selection comprised the following steps:
(1) emplacement of a multiplicity of candidate ligand components into an emplacement site in a living mammal, in a manner that caused contact between said candidate ligand components, and surfaces of neuronal fibers;
(2) harvesting, at a harvesting site located away from the emplacement site, isolated segments of neuronal fibers that contained ligand components that had been successfully internalised and transported by the neuronal fibers; and,
(3) removing, from said isolated segments of neuronal fibers, ligand components that had been internalised and transported by the neuronal fibers.

21. The purified preparation of claim 17, wherein candidate ligand components were exposed on phage particle surfaces in a phage display library, during the in vivo selection process.

22. The purified preparation of claim 17, wherein candidate ligand components that were screened by the in vivo selection process were generated by a process of combinatorial chemical synthesis.

23. The purified preparation of claim 15, wherein candidate ligand components that were screened by the in vivo selection process were processed by an affinity binding step prior to the in vivo selection process.

24. The purified preparation of claim 15, wherein the ligand component specifically binds to low-affinity nerve growth receptors.

25. An in vivo selection process for isolating endocytotic ligands that can enable endocytotic uptake of molecular complexes, containing said endocytotic ligands coupled to passenger components, into targeted cells having endocytotic surface molecules to which the endocytotic ligands will specifically bind, comprising the following steps:
(1) emplacing a multiplicity of candidate ligand components into an emplacement site in a living mammal, in a manner that caused in vivo contact between said candidate ligand components, and surfaces of neuronal fibers;
(2) harvesting, at a harvesting site located away from the emplacement site, isolated segments of neuronal fibers that contained ligand components that had been successfully internalised and transported by the neuronal fibers; and,
(3) removing, from said isolated segments of neuronal fibers, ligand components that had been internalised and transported by the neuronal fibers.

26. The in vivo selection process of claim 25, wherein the candidate ligand components were exposed on phage particle surfaces in a phage display library, during the in vivo selection process.

27. The in vivo selection process of claim 25, wherein the candidate ligand components were generated by a process of combinatorial chemical synthesis.

28. The in vivo selection process of claim 25, wherein the candidate ligand components were processed by an affinity binding step prior to the in vivo selection process.

29. The in vivo selection process of claim 25, wherein the neuronal fibers are treated in a manner that will increase expression of low-affinity nerve growth receptors, prior to the in vivo selection process.

30. A method for introducing foreign molecules into a selected class of targeted mammalian cells, comprising the step of contacting the targeted mammalian cells with at least one copy of an endocytotic molecular complex that comprises:
a. at least one ligand component that was identified by a process of in vivo selection that required endocytotic uptake into neuronal fibers for such selection to occur, and,
b. at least one passenger component capable of causing a desired effect after such passenger component has been transported into a targeted mammalian cell having endocytotic surface molecules to which the ligand component will specifically bind.

31. The method of claim 30, wherein the endocytotic molecular complex also comprises at least one coupling component that couples the passenger component to the ligand component in a manner that enables the passenger component to enter the targeted mammalian cells when the molecular complex undergoes ligand-mediated endocytotic transport into such cells.

32. The method of claim 30, wherein the process of in vivo selection comprised the following steps:
(1) emplacing a multiplicity of candidate ligand components into an emplacement site in a living mammal, in a manner that caused contact between said candidate ligand components, and surfaces of neuronal fibers;
(2) harvesting, at a harvesting site located away from the emplacement site, isolated segments of neuronal fibers that contained ligand components that had been successfully internalised and transported by the neuronal fibers; and,
(3) removing, from said isolated segments of neuronal fibers, ligand components that had been internalised and transported by the neuronal fibers.

33. The method of claim 31, wherein the candidate ligand components were exposed on phage particle surfaces in a phage display library, during the in vivo selection process.

34. The method of claim 32, wherein the candidate ligand components were generated by a process of combinatorial chemical synthesis.

35. The method of claim 32, wherein the candidate ligand components were processed by an affinity binding step prior to the in vivo selection process.

36. The method of claim 30, wherein the neuronal fibers were treated in a manner that increased expression of low-affinity nerve growth receptors, prior to the in vivo selection process.

37. The method of claim 30, wherein the ligand component specifically binds to low-affinity nerve growth receptors.

38. A phage display library, comprising a multiplicity of phages that display at least one candidate ligand sequence in at least one coat protein, wherein said phage display library has been prescreened by an affinity binding step which utilized affinity binding to a polypeptide that is known to have endocytotic activity on animal cells to select phage particles that are included in the library.
